(19) United States
(12) Patent Application Publication
(10) Pub. No.: US 2015/0125545 A1
(43) Pub. Date: May 7, 2015

(54) AQUACULTURE WATER TREATMENT SYSTEMS AND METHODS

(71) Applicant: Aardvark IP Holding, LLC, Denver, CO (US)

(72) Inventors: David Kolstad, Denver, CO (US); David Sunshine, Greenwood Village, CO (US)

(21) Appl. No.: 14/495,702

(22) Filed: Sep. 24, 2014

Related U.S. Application Data
(60) Provisional application No. 61/899,678, filed on Nov. 4, 2013.
(60) Provisional application No. 62/015,162, filed on Jun. 20, 2014.

(51) Int. Cl. C02F 1/72; A01N 59/00; C02F 1/50

(52) U.S. Cl. CPC C02F 1/727; C02F 1/50; A01N 59/00; C02F 2103/007
USPC 424/613

(57) ABSTRACT

A water treatment device and methods of treating water such as in aquaculture systems, are described. The water treatment device utilizes oxygen containing air that is exposed to ultraviolet radiation and to a magnetic field to treat the water resulting in reduced and controlled Vibrio bacterial levels in the treated water.

### CROSS REFERENCE TO RELATED APPLICATIONS

The present application claims the benefits of U.S. Provisional Application Ser. Nos. 61/899,678, filed Nov. 4, 2013 and 62/015,162, filed Jun. 20, 2014 both entitled “Water Treatment Systems and Methods”, each of which is incorporated herein by this reference in its entirety.

### FIELD OF THE INVENTION

The disclosed invention pertains generally to systems and methods for treating aquaculture waters. More particularly, embodiments of the disclosed invention utilize ultraviolet light and/or magnets to treat aquaculture shrimp farming waters.

### BACKGROUND

Water treatment is required to generate or maintain acceptable water quality in systems such as in aquaculture systems.

Common inhabitants of costal and estuarine environments include bacteria of the species Vibrio, including Vibrio parahaemolyticus (also referred to herein as V. parahaemolyticus and VP). Hence, they are often found naturally associated with shrimp aquaculture systems. Certain environmental conditions may be more favorable for the establishment, survival and growth of the organism such as temperature, salinity, zooplankton, tidal flushing and dissolved oxygen. V. parahaemolyticus is closely related to shrimp pathogenic luminous bacteria such as Vibrio harveyi (V. harveyi), Vibrio campbelli (V. campbelli) and Vibrio owensii (V. owensii). These along with other closely related Vibrio spp form a “V. harveyi Glade” (Cano-Gomez et al., “Vibrio owensii sp. nov., isolated from cultured crustaceans in Australia”, FEMS Microbiol Lett. 2010 January; 302(2):175-81). Bacteria within this Glade have a very high degree of similarity at both the phenotypic and genotypic levels.

V. parahaemolyticus, which has virulent and benign strains, causes Acute Hepatopancreatic Necrosis Disease (AHPND) or Early Mortality Syndrome (EMS) in shrimp. AHPND damages the digestive system of shrimp and causes mortality, often within thirty days of stocking V. parahaemolyticus tolerates a range of salinities, pH and temperatures, readily attaches to marine plankton and may be spread by ocean currents (Chamberlain, G. EMS. Volume 16, Issue 6, page 14, November/December 2013). At extremely dense populations, the colonies coordinate the release of a communication chemical (a potent toxin) through a process known as quorum sensing (Hardman A. M., et al., Antonie van Leeuwenhoek 74:199-210, 1998). V. parahaemolyticus has caused significant losses for the shrimp aquaculture industry worldwide, which results in a loss of shrimp production, jobs and profits.

Certain strains of V. parahaemolyticus can also cause gastroenteritis in humans and clinical strains are characterized by the ability to produce a thermostable direct hemolysin (TDH) or a TDH-related hemolysin (TRH).

### SUMMARY

Embodiments of the present disclosure are directed to solving these and other problems and overcoming the disadvantages of aquaculture systems of the prior art. More particularly, embodiments of the disclosed systems and methods provide for the maintenance and/or improvement of aquaculture shrimp farming water quality. As examples, and without limitation, embodiments of the present disclosure can be applied in connection with maintaining water quality. Treatment systems and methods as disclosed herein utilize ultraviolet (UV) radiation or light.

Some embodiments of the invention relate to a method to control and/or reduce the level of bacteria of the species Vibrio and combinations thereof in aquaculture water. Yet another embodiment of the invention relates to a method to inhibit growth of bacteria of the species of Vibrio and combinations thereof in aquaculture water.

In accordance with some embodiments, the method includes providing a treated oxygen-containing gas generated by passing an oxygen-containing gas stream through ultra-violet radiation in a magnetic field and, thereafter, contacting a bacteria-containing aquaculture water with the treated oxygen-containing gas to form treated aquaculture water. The level of Vibrio bacteria in the treated aquaculture water can be one of controlled, reduced, or both controlled and reduces as compared to the level of Vibrio bacteria prior to the step of contacting the treated oxygen-containing gas with the bacteria-containing aquaculture water. In some embodiments, the level of Vibrio bacteria in the treated aquaculture water is reduced as compared to the level of Vibrio bacteria prior to the step of contacting the treated oxygen-containing gas with the bacteria-containing aquaculture water. For example, the level of the Vibrio bacteria can be reduced to a level of about 1×10¹ CFU/ml to about 5×10⁷ CFU/ml. In some embodiments, the Vibrio bacteria in the treated aquaculture water is controlled as compared to the level of Vibrio bacteria prior to the step of contacting the treated oxygen-containing gas with the bacteria-containing aquaculture water. For example, the level of the Vibrio bacteria can be reduced to a level of about 1×10¹ CFU/ml to about 5×10⁷ CFU/ml. In another non-limiting example, the growth of bacteria can be inhibited to a level of about 1×10¹ CFU/ml to about 5×10⁷ CFU/ml. The species of Vibrio can be Vibrio parahaemolyticus, Vibrio harveyi, V. campbelli, V. owensii, Vibrio cholerae (also referred to as V. cholerae) or combinations thereof. In some embodiments, the species of Vibrio is Vibrio parahaemolyticus.

It can be appreciated that the method of one of controlling, reducing or both controlling and reducing the level of bacteria of the species Vibrio in water allows for shrimp surviving and growing in the treated aquaculture water.

In accordance with some embodiments, the aquaculture water is in a sealed aerated pond, in a marine environment or in an aquaculture farming system.

Some embodiments of the invention relate to a method to reduce the incidence of acute hepatopancreatic necrosis syndrome (AHPNS) caused by the presence of bacteria in shrimp growing in an aquaculture water, by one of controlling, reducing, or both of controlling and reducing the level of bacteria in the aquaculture water by providing a treated oxygen-containing gas generated by passing an oxygen-containing gas stream through ultra-violet radiation in a magnetic field and, thereafter, contacting the aquaculture water with the treated oxygen-containing gas to form treated aquaculture water. The treated aquaculture water has a level of bacteria of about 1×10¹ CFU/ml to about 5×10⁷ CFU/ml.

Some embodiments of the method relates to reducing the bacteria level in the aquaculture water by providing a treated oxygen-containing gas generated by passing an oxygen-containing gas stream through ultra-violet radiation in a magnetic field and, thereafter, contacting the aquaculture water having a first level of bacteria with the treated oxygen-containing gas to form a treated aquaculture water having a second level of bacteria. The second level of bacteria is no greater than the first level of bacteria. For example, the second level of bacteria is from about 1×10¹ CFU/ml to about 5×10⁷ CFU/ml.

In some embodiments, the method relates to maintaining the level of bacteria in the aquaculture water by providing a treated oxygen-containing gas generated by passing an oxygen-containing gas stream through ultra-violet radiation in a magnetic field and, thereafter, contacting the aquaculture water having a first level of bacteria with the treated oxygen-containing gas to form a treated aquaculture water having a second level of bacteria. The second level of bacteria is from about 1×10¹ CFU/ml to about 5×10⁷ CFU/ml.

In accordance with some embodiments the invention relates to a method to treat shrimp growing in an aquaculture water having acute hepatopancreatic necrosis syndrome caused by the presence of bacteria, by one of controlling, reducing, or both controlling and reducing the level of bacteria in the aquaculture water by providing a treated oxygen-containing gas generated by passing an oxygen-containing gas stream through ultra-violet radiation in a magnetic field and, thereafter, contacting the aquaculture water with the treated oxygen-containing gas to a treated aquaculture water. The treated aquaculture water has a level of bacteria of about 1×10¹ CFU/ml to about 5×10⁷ CFU/ml.

In some embodiments, the method relates to reducing the level of bacteria in the aquaculture water by providing a treated oxygen-containing gas generated by passing an oxygen-containing gas stream through ultra-violet radiation in a magnetic field and, thereafter, contacting the aquaculture water having a first level of bacteria with the treated oxygen-containing gas to form treated aquaculture water having a second level of bacteria. The second level of bacteria is no greater than the first level of bacteria. The second level of bacteria is from of about 1×10¹ CFU/ml to about 5×10⁷ CFU/ml.

In some embodiments, the method relates to controlling the level of bacteria in the aquaculture water by providing a treated oxygen-containing gas generated by passing an oxygen-containing gas stream through ultra-violet radiation in a magnetic field and, thereafter, contacting the aquaculture water with the treated oxygen-containing gas to form treated aquaculture water. The treated aquaculture water has a level of bacteria from about 1×10¹ CFU/ml to about 5×10⁷ CFU/ml.

In accordance with the above embodiments, the bacteria are of the species of Vibrio and combinations thereof. The Vibrio species can be selected from the group consisting of Vibrio parahaemolyticus, Vibrio harveyi, V. campbelli, V. owensii, Vibrio cholerae and combinations thereof.

In accordance with some of the above embodiments, the water is contacted with the treated oxygen-containing gas until the level of bacteria in the water is from about 1×10¹ CFU/ml to about 5×10⁷ CFU/ml. In some of the embodiments, the water is contacted with the treated oxygen-containing gas continuously during the step of contacting the treated oxygen-containing gas with the bacteria-containing water. In some embodiments, the water is contacted with the treated oxygen-containing gas at two or more different intervals during the step of contacting the treated oxygen-containing gas with the bacteria-containing water.

According to some of the methods disclosed herein, the method can further include treating aquaculture water by contacting an oxygen-containing gas stream with ultraviolet radiation to form treated oxygen gas and, thereafter, contacting an aquaculture water stream with the treated gas to form a treated aquaculture water. The method can include contacting the oxygen containing gas stream with the ultraviolet radiation within a magnetic field. The magnetic field can be established between two parallel sets of magnets with alternating magnetic poles. The oxygen-containing gas stream can comprise air. Moreover, contacting the oxygen containing gas stream with ultraviolet radiation can be performed at a pressure greater than ambient pressure, preferably at a pressure of from about 55 inches to about 4,000 inches of water greater than ambient atmospheric pressure. The ultraviolet radiation can include wavelengths of at least about 178 nm to about 187 nm as well as from about 252 nm to about 256 nm. The ultraviolet radiation can comprise substantially ultraviolet radiation of about 180 nm and about 254 nm wavelengths. Contacting the aquaculture water with the treated oxygen gas stream can include at least one of: forming a dispersion of the treated oxygen gas in the aquaculture water; bubbling the treated oxygen gas into the aquaculture water; and introducing the treated oxygen gas through a venturi effect to the aquaculture water.

Embodiments can additionally utilize magnetic fields. The UV radiation and/or magnetic fields can be applied directly to aquaculture water, in order to treat that aquaculture water. Alternatively or in addition, the UV radiation and/or magnetic fields can be applied to a gas, such as air, and the treated gas can then be placed in contact with aquaculture water, in order to treat the aquaculture water.

In accordance with exemplary embodiments of the present disclosure, the UV radiation can comprise ultraviolet radiation having multiple wavelengths. For example, UV radiation at wavelengths of about 180 nm and about 254 nm can be utilized. Magnets can be provided as part of linear arrays. Moreover, such linear arrays can be arranged in pairs. As an example, a pair of linear arrays of magnets can be located adjacent a UV lamp within a treatment chamber, in order to treat a gas contained within the treatment chamber with UV radiation and a magnetic field simultaneously.

In accordance with at least some embodiments, a gas is treated with UV radiation and the treated gas is then placed in contact with aquaculture water. A pump can be provided to supply pressurized air to a treatment chamber containing a UV light source. The treatment chamber can additionally include linear arrays of magnets. Pressurized gas exposed to the UV radiation and, if magnets are provided, a magnetic field, then exits the treatment chamber and is placed in contact with the aquaculture water to be treated.

Embodiments of the present disclosure are related to systems for treating aquaculture water. Such systems can include a treatment chamber housing that defines an interior volume. A treatment chamber inlet is operable to admit air into the interior volume of the treatment chamber housing. Located within the treatment chamber housing is a UV radiation source. A treatment chamber outlet is provided that is operable to exhaust air from the interior volume of the treatment chamber housing.

Systems can include additional elements, alone or in combination. Such elements include, for example, an air pump, wherein an outlet of the air pump provides a flow of air to the treatment chamber inlet. The UV radiation source can be operable to emit ultraviolet radiation at a plurality of wavelengths, including radiation having a first wavelength that is within a range of from about 178 nm to about 187 nm, and including light at a second wavelength that is within a range from about 252 nm to about 256 nm. The system can further include a plurality of UV radiation sources within the interior volume of the treatment chamber housing. A plurality of magnets can be included within the interior of the treatment chamber. The magnets can be arrayed along at least a first line, forming a linear array, wherein the polarity of the magnets arrayed along the first line are such that a first magnet in the line repels a second magnet in the line. In accordance with still further embodiments, the magnets can be arrayed along at least first and second lines, wherein the polarity of the magnets arrayed along the first line are such that a first magnetic repels a second magnet in the first line, wherein the polarity of the magnets arrayed along the second line are such that a first magnet repels a second magnet in the second line, wherein the first magnet of the first line is adjacent the first magnet of the second line, wherein the second magnet of the first line is adjacent the second magnet of the second line, and wherein the first adjacent magnets and the second adjacent magnets have magnetic fields or polarities that are oppositely aligned.

Other embodiments provide systems for treating aquaculture water that can include an air pump. In addition, the systems can include a first treatment chamber having a treatment chamber housing that defines an interior volume or a first treatment volume, and an inlet to the interior volume, wherein the inlet is interconnected to an outlet of the air pump by at least a first supply tube or conduit. The systems can further include an outlet from the interior volume. In addition, a UV light source is located within the interior volume of the first treatment chamber.

Systems can additionally include other elements alone or in combination. For instance, a system can include a second treatment chamber. The second treatment chamber can have a treatment chamber housing, wherein the treatment chamber housing defines an interior volume or treatment volume of the second treatment chamber, an inlet to the interior volume, wherein the inlet is interconnected to an outlet of the air pump by at least a second supply tube or conduit, and an outlet from the interior volume. A second UV radiation source is located within the interior volume of the second treatment chamber. In addition, a common outlet, wherein the outlet from the interior volume of the first treatment chamber and the outlet from the interior volume of the second treatment chamber are interconnected to the common outlet, can also be provided. The first treatment chamber can further include a first plurality of magnets arranged along a first line, wherein an orientation of magnets within the first plurality of magnets alternates. The first treatment chamber can additionally include a second plurality of magnets arranged along a second line, wherein an orientation of the magnetic poles of magnets within the second plurality of magnets alternates, and wherein an orientation of the magnetic poles of each magnet in the first plurality of magnets is reversed from an adjacent magnet in the second plurality of magnets. Similarly, the second treatment chamber can include a third plurality of magnets arranged along a third line, wherein an orientation of the magnetic poles of magnets within the third plurality of magnets alternates, and a fourth plurality of magnets arranged a fourth line, wherein an orientation of magnets within the fourth plurality of magnets alternates, and wherein an orientation of the magnetic poles of each magnet in the third plurality of magnets is reversed from an adjacent magnet in the fourth plurality of magnets.

In accordance with a first embodiment is a method to control the level of bacteria of the species of Vibrio and combinations thereof in bacteria-containing water by providing a treated oxygen-containing gas generated by passing an oxygen-containing gas stream through ultra-violet radiation in a magnetic field, and contacting the bacteria-containing water with the treated oxygen-containing gas to form a treated water, where the level of bacteria in the treated water is controlled as compared to the level of Vibrio bacteria prior to the step of contacting the bacteria-containing water with the treated oxygen-containing gas.

In accordance with a second embodiment is method to reduce the level of bacteria of the species of Vibrio and combinations thereof in bacteria-containing water by providing a treated oxygen-containing gas generated by passing an oxygen-containing gas stream through ultra-violet radiation in a magnetic field, and contacting the bacteria-containing water with the treated oxygen-containing gas to form a treated water, where the treated water has a reduced concentration of the bacteria as compared to the level of bacteria prior to the step of contacting the bacteria-containing water with the treated gas.

In accordance with a third embodiment is a method to inhibit growth of bacteria of the species of Vibrio and combination thereof in water by providing a treated oxygen-containing gas generated by passing an oxygen-containing gas stream through ultra-violet radiation in a magnetic field, and contacting the water with the treated oxygen-containing gas to form a treated water, where the step of contacting the treated oxygen-containing gas with the bacteria-containing water inhibits growth of the bacteria.

In accordance with the first embodiment, the level of bacteria is controlled to a level of about 1×10¹ CFU/ml to about 5×10⁷ CFU/ml.

In accordance with the second embodiment, the level of bacteria is reduced to a level of about 1×10¹ CFU/ml to about 5×10⁷ CFU/ml.

In accordance with the third embodiment, the growth of bacteria is inhibited to a level of about 1×10¹ CFU/ml to about 5×10⁷ CFU/ml.

In accordance with any one of first, second or third embodiments, the species of Vibrio is selected from the group consisting of Vibrio parahaemolyticus, Vibrio harveyi, V. campbelli, Vibrio cholerae and V. owensii, and combinations thereof.

In accordance with any one of first, second or third embodiments, the species is Vibrio parahaemolyticus.

In accordance with any one of first, second or third embodiments, the treated water allows for survival of shrimp growing in the water.

In accordance with any one of first or second embodiments, the bacteria-containing water is in a sealed aerated pond, a marine environment or an aquaculture system.

In accordance with the third embodiment, the water is in a sealed aerated pond, a marine environment, or an aquaculture system.

In accordance with a fourth embodiment, is a method to reduce the incidence of acute hepatopancreatic necrosis syndrome (AHPNS) caused by the presence of bacteria in shrimp growing in bacteria-containing water, by reducing the level of bacteria in the bacteria-containing water by providing a treated oxygen-containing gas generated by passing an oxygen-containing gas stream through ultra-violet radiation in a magnetic field, and contacting the bacteria-containing water with the treated oxygen-containing gas to form a treated water, where the treated water has a level of bacteria of about 1×10¹ CFU/ml to about 5×10⁷ CFU/ml as compared to prior to the step of contacting the treated oxygen-containing gas with the bacteria-containing water.

In accordance with a fifth embodiment is a method to reduce the incidence of acute hepatopancreatic necrosis syndrome (AHPNS) caused by the presence of bacteria in shrimp growing in bacteria-containing water, by controlling the level of bacteria in the bacteria-containing water by providing a treated oxygen-containing gas generated by passing an oxygen-containing gas stream through ultra-violet radiation in a magnetic field, and contacting the bacteria-containing water with the treated oxygen-containing gas to form a treated water, where the treated water has a level of bacteria of about 1×10¹ CFU/ml to about 5×10⁷ CFU/ml as compared to prior to the step of contacting the treated oxygen-containing gas with the bacteria-containing water.

In accordance with a sixth embodiment is a method to treat shrimp growing in bacteria-containing water having acute hepatopancreatic necrosis syndrome caused by the presence of bacteria, by reducing the level of bacteria in the bacteria-containing water by providing a treated oxygen-containing gas generated by passing an oxygen-containing gas stream through ultra-violet radiation in a magnetic field, and contacting the bacteria-containing water with the treated oxygen-containing gas to form a treated water, where the treated water has a level of bacteria of about 1×10¹ CFU/ml to about 5×10⁷ CFU/ml as compared to prior to the step of contacting the treated oxygen-containing gas with the bacteria-containing water.

In accordance with the seventh embodiment is a method to treat shrimp growing in bacteria-containing water having acute hepatopancreatic necrosis syndrome caused by the presence of bacteria, by controlling the level of bacteria in the bacteria-containing water by providing a treated oxygen-containing gas generated by passing an oxygen-containing gas stream through ultra-violet radiation in a magnetic field, and contacting the bacteria-containing water with the treated oxygen-containing gas to form a treated water, where the contacted water has a level of bacteria of about 1×10¹ CFU/ml to about 5×10⁷ CFU/ml as compared to prior to the step of contacting the treated oxygen-containing gas with the bacteria-containing water.

In accordance with any of the fourth, fifth, sixth and seventh embodiments, the bacteria are of the species Vibrio.

In accordance with any of the fourth, fifth, sixth and seventh embodiments, the bacteria are of the species Vibrio, and the Vibrio species is selected from the group consisting of Vibrio parahaemolyticus, Vibrio harveyi, V. campbelli V. owensii, Vibrio cholerae, and combinations thereof.

In accordance with any one of first through seventh embodiments, the bacteria-containing water is contacted with treated oxygen-containing gas until the level of bacteria in the bacteria-containing water is from about 1×10¹ CFU/ml to about 5×10⁷ CFU/ml.

In accordance with any one of the first through seventh embodiments, the bacteria-containing water is continuously contacted with the treated oxygen-containing gas until the level of bacteria in the bacteria-containing water is from about 1×10¹ CFU/ml to about 5×10⁷ CFU/ml.

In accordance with any one of the first through seventh embodiments, the bacteria-containing water is contacted at two or more different intervals during the step of contacting the treated oxygen-containing gas until the level of bacteria in the bacteria-containing water is from about 1×10¹ CFU/ml to about 5×10⁷ CFU/ml.

In accordance with any one of first through seventh embodiments, the bacteria-containing water is contacted with treated oxygen-containing gas until the level of bacteria in the bacteria-containing water is from about 1×10¹ CFU/ml to about 5×10⁷ CFU/ml, where the step of contacting is be selected from the group consisting of forming a dispersion of the treated oxygen gas in the water, bubbling the treated oxygen gas into the water, and introducing the treated oxygen gas through a venturi effect to the water.

In accordance with any one of the first through seventh embodiments, the bacteria-containing water is continuously contacted with the treated oxygen-containing gas until the level of bacteria in the bacteria-containing water is from about 1×10¹ CFU/ml to about 5×10⁷ CFU/ml, where the step of contacting is be selected from the group consisting of forming a dispersion of the treated oxygen gas in the water, bubbling the treated oxygen gas into the water, and introducing the treated oxygen gas through a venturi effect to the water.

In accordance with any one of the first through seventh embodiments, the bacteria-containing water is contacted at two or more different intervals during the step of contacting the treated oxygen-containing gas until the level of bacteria in the bacteria-containing water is from about 1×10¹ CFU/ml to about 5×10⁷ CFU/ml wherein the water is contacted continuously during the step of contacting, where the step of contacting is be selected from the group consisting of forming a dispersion of the treated oxygen gas in the water, bubbling the treated oxygen gas into the water, and introducing the treated oxygen gas through a venturi effect to the water.

In accordance with any one of the first through seventh embodiments, the step of contacting can be selected from the group consisting of forming a dispersion of the treated oxygen gas in the water, bubbling the treated oxygen gas into the water, and introducing the treated oxygen gas through a venturi effect to the water.

In accordance with any one of the first through seventh embodiments, the ultra-violet radiation has a first wavelength within a range from about 178 nm to about 187 nm and a second wavelength with a range from about 252 nm to about 256 nm.

In accordance with any one of the first through seventh embodiments, the magnetic field is established by one of: (i) a set of magnets with magnetic fields aligned to one of attract an adjacent magnet or repel an adjacent magnet; (ii) a plurality of permanent magnets; (iii) a plurality of electromagnets; and (v) two parallel sets of magnets with one of opposing or attractive magnetic poles.

Additional features and advantages of embodiments of the present disclosure will become more readily apparent from the following description, particularly when taken together with the accompanying drawings.

### BRIEF DESCRIPTION OF THE DRAWINGS

FIG. 1 is a side view of a water treatment device according to one embodiment of the present invention;

FIGS. 2A-2C are side views of arrangements of magnetic poles and their magnetic fields in water treatment devices according to various embodiments of the present invention;

FIG. 3 is a side view of a water treatment device according to one embodiment of the present invention;

FIG. 4 is a side view of a water treatment system according to one embodiment of the present invention;

FIG. 5 depicts a water treatment system in accordance with embodiments of the present disclosure;

FIG. 6 is a cross-section of a treatment chamber in accordance with embodiments of the present invention;

FIG. 7 is a flowchart depicting aspects of a method for treating water in accordance with embodiments of the present invention;

FIG. 8 shows Vibrio species counts before and after treating vibro-containing water in accordance with embodiments of the present invention;

FIG. 9 shows Vibrio species counts before and after treating vibro-containing water in accordance with embodiments of the present invention;

FIG. 10 shows Vibrio species counts before and after treating vibro-containing water in accordance with embodiments of the present invention;

FIG. 11 shows the population of V. parahaemolyticus in water after treating V. parahaemolyticus-containing water in accordance with embodiments of the present invention;

FIG. 12 shows the population of V. parahaemolyticus in the sediment after treating V. parahaemolyticus-containing water in accordance with embodiments of the present invention;

FIG. 13 shows kill rates after treating V. parahaemolyticus-containing water in accordance with embodiments of the present invention; and

FIG. 14 shows the population of Vibrio species, including Vibrio cholerae in water after treating the Vibrio containing water in accordance with embodiments of the present invention.

### DETAILED DESCRIPTION

The inventor of the present invention has found the surprising result that a treated oxygen-containing gas generated by passing an oxygen-containing gas stream through ultra-violet radiation in a magnetic field as disclosed herein, is able to control, reduce, or both control and reduce the amount of bacteria of the species of Vibrio and combinations thereof contained in an aquaculture water. For example, the inventor has found the surprising result that a treated oxygen-containing gas generated by passing an oxygen-containing gas stream through ultra-violet radiation in a magnetic field as disclosed herein, is able to control, reduce or both control and reduce the amount of Vibrio species, such as but not limited to Vibrio parahaemolyticus, to low levels in aquaculture waters and systems, thus promoting survival of cultured crustaceans, such as but not limited to shrimp.

Embodiments of the present invention comprise a method of treating aquaculture waters with a treated oxygen-containing gas generated by passing an oxygen-containing gas stream through ultra-violet radiation in a magnetic field. This method produces a powerful oxidizing capacity as a disinfectant and is very efficient at one or more of controlling, reducing, or both of controlling and reducing the levels of Vibrio bacteria in aquaculture water.

Aquaculture water, which includes waters in which aquatic organisms, such as shrimp, are cultivated in, can contain bacteria of the Vibrio species and combinations thereof.

Embodiments of the water treatment method disclosed herein can control the level or amount of bacteria of the species Vibrio in aquaculture water. In one aspect, the water treatment method disclosed herein reduces the level or amount of the bacteria of the species Vibrio. Aquaculture water, treated by the water treatment method disclosed herein can limit, reduce, or both limit and reduce bacterial colonies compared to untreated water or water prior to treatment to be within a desired range, thus controlling the levels of the bacterial colonies within the aquaculture water. For example, aquaculture water treated by the water treatment method disclosed herein, can be within a range having a lower end of bacteria colony forming units per milliliter (CFU/ml) of about 1×10¹ CFU/ml, about 5×10² CFU/ml, about 1×10² CFU/ml, about 5×10² CFU/ml, about 1×10³ CFU/ml, about 5×10³ CFU/ml, about 1×10⁴ CFU/ml, or about 5×10⁴ CFU/ml. In addition, aquaculture water treated by the water treatment method disclosed herein can be within a range commonly having a higher end of bacteria (CFU/ml) of about 1×10⁴ CFU/ml, more commonly about 5×10⁴ CFU/ml, even more commonly about 1×10⁵ CFU/ml, yet even more commonly about 5×10⁵ CFU/ml, still yet even more commonly about 1×10⁶ CFU/ml, still yet even more commonly about 5×10⁶ CFU/ml, still yet even more commonly about 1×10⁷ CFU/ml or yet still even more commonly about 5×10⁷ CFU/ml.

The aquaculture water can be contacted by a treated oxygen-containing gas generated by passing an oxygen-containing gas stream through ultra-violet radiation in a magnetic field as disclosed herein. The Vibrio bacteria (CFU/ml) in the aquaculture water can be identified, monitored or both identified and monitored. Moreover, one or both of high and low threshold levels of Vibrio bacteria (CFU/ml) in the aquaculture water can be identified, monitored or both identified and monitored.

Monitoring of the Vibrio bacterial level can occur over various times, including but not limited to seconds, minutes, hours, days, months and years. The aquaculture water can be contacted or dosed with the treated oxygen-containing gas disclosed herein so that the bacterial level can be maintained, controlled, or both of maintained and controlled at a level below the high threshold level. In some embodiments, the contacting of the aquaculture water with the treated oxygen-containing gas disclosed herein is stopped so that the bacteria level can be one or both of maintained and controlled above the low threshold level. The dosing or contacting can commence again if the high threshold level is reached and the dosing or contacting cycle can be repeated in order to one or both of maintain and control the level of bacteria within the high and low threshold levels. High and low threshold levels of bacteria can vary depending on size and depth of the aquaculture water as well as the Vibrio species present in the aquaculture water. In addition, the exposure or contact time of the treated oxygen-containing gas with the aquaculture water can vary by the salinity, temperature nutrient load and Vibrio species within the aquaculture water.

While not wanting to be limited by example, the aquaculture water treatment method can reduce the average free-floating Heterotrophic Plate Count (HPC) bacteria, and bacterial growth of the species Vibrio in water. For example, the average free-floating HPC bacteria concentration can be commonly reduced by more than about 90%, more commonly by more than about 95%, even more commonly by more than about 98%, yet even more commonly by more than about 99%, or still yet even more commonly by more than about 99.9%. Aquaculture water treated by the water treatment method disclosed herein can meet the generally accepted industry recommended levels for the species Vibrio for aquaculture systems. Moreover, the water treatment method can commonly achieve at least about 70% reduction in concentration of immobile HPC bacteria, more commonly about 75% reduction in concentration of immobile HPC bacteria, even more commonly about 80% reduction in concentration of immobile HPC bacteria, yet even more commonly about 85% reduction in concentration of immobile HPC bacteria, or still yet even more commonly about 90% reduction in concentration of immobile HPC bacteria. Aquaculture waters treated by the water treatment method typically have a reduction in Vibrio bacteria concentrations and/or levels of about at least 50%, more typically of about at least 60%, even more typically of about at least 65%, yet even more typically of about at least 70%, still yet even more typically of about at least 75%, still yet even more typically of about at least 80%, still yet even more typically of about at least 85%, still yet even more typically of about at least 90%, or yet still even more typically of about at least 99%. The water treatment method disclosed herein can nearly eradicate bacteria of the species Vibrio in aquaculture waters.

For aquaculture water treated with the water treatment method disclosed herein, the HPC levels of the aquaculture water can be typically reduced by a factor of at least 25, more typically by a factor of about 50, or more typically by a factor of about 100 compared to untreated waters. Moreover, levels of bacteria of the species Vibrio in aquaculture waters can be commonly reduced by the water treatment method disclosed herein by about a factor of about 1 log 10 reduction, more commonly about 2 log 10 reduction, even more commonly about 3 log 10 reduction, yet even more commonly about 4 log 10 reduction, still yet even more commonly about 5 log 10 reduction, or yet still even more commonly about 6 log 10 reduction. Moreover, the levels or concentration of bacteria of the species Vibrio can be reduced by the water treatment method disclosed herein by about 50%, about 60%, about 70%, about 80%, about 90%, about 95%, about 99%, or about 99.9%. Furthermore, the water treatment method disclosed herein can nearly eradicate bacteria of the species Vibrio in aquaculture waters.

In some embodiments, the aquaculture waters treated by the water treatment method disclosed herein can be aquaculture waters in sealed aerated ponds, marine environments as well as other aquaculture water systems know to those of ordinary skill in the art.

Embodiments of the water treatment method disclosed herein can reduce the incidence of acute hepatopancreatic necrosis syndrome (AHPNS) caused by the presence of bacteria, such as bacteria of the species Vibrio, in shrimp growing in aquaculture waters by reducing the level of bacteria in the aquaculture water.

Embodiments of the water treatment method disclosed herein can be used to treat shrimp growing in an aquaculture water having acute hepatopancreatic necrosis syndrome caused by the presence of bacteria, such as bacteria of the species Vibrio, by reducing the level of bacteria in the aquaculture water.

In some embodiments, the aquaculture water can be exposed to the water treatment device disclosed herein or contacted (or dosed) with a treated oxygen-containing gas produced by the water treatment method disclosed herein for a contact period of one of at least about 15 seconds, at least about 45 seconds, at least about 60 seconds, at least about 120 seconds, at least about 1 hour, at least about 5 hours, at least about 10 hours, at least about 15 hours, or at least about 24 hours. In some embodiments, the aquaculture water can be contacted (such as exposed to or dosed) with a treated oxygen-containing gas produced by the water treatment method disclosed herein one time or more than one time (i.e. one or more doses, contacting or exposure). In some embodiments, the aquaculture water can be contacted (or exposed or dosed) with the treated oxygen-containing gas produced by the water treatment method disclosed herein at two or more different time intervals. In some embodiments, the aquaculture water can be contracted (or exposed or dosed) with the treated oxygen-containing gas produced by the water treatment method disclosed herein continuously over a short or long period of time. In still other embodiments, the aquaculture water can be contacted (or exposed or dosed) with the treated oxygen-containing gas produced by the water treatment method disclosed herein intermediately over a short or long period of time. The aquaculture water treatment can be contacted (or exposed or dosed) with the treated oxygen-containing gas produced by the water treatment method disclosed herein for different periods of time depending on size and depth of the aquaculture water as well as the Vibrio species present in the aquaculture water. In addition, the contact period (or exposure or period of dosage) of aquaculture water with the treated oxygen-containing gas produced by the water treatment method disclosed herein can vary by the salinity, temperature nutrient load and strain of bacteria within the aquaculture water. The dosing time can be a short period of time or a long period of time. For example, a long contacting (or exposure or dosing) period of time can be the period of from the first dose to the period of harvesting the shrimp.

In some embodiments, the aquaculture water can be exposed to oxygen containing gas powered by the water treatment device disclosed herein or contacted (or dosed) with the treated oxygen-containing gas produced by the water treatment method disclosed herein with a dosage of about 1 liter (L_{g}) per of treated oxygen-containing gas minute (min) per 380 liters (L_{w}) of aquaculture water (L_{g}/min/(380 L_{w}), about 2 L_{g}/min/(380 L_{w}), about 3 L_{g}/min/(380 L_{w}), about 4 L_{g}/min/(380 L_{w}), about 5 L_{g}/min/(380 L_{w}), about 6 L_{g}/min/(380 L_{w}), about 7 L_{g}/min/(380 L_{w}), about 8 L_{g}/min/(380 L_{w}), about 9 L_{g}/min/(380 L_{w}), about 10 L_{g}/min/(380 L_{w}), about 11 L_{g}/min/(380 L_{w}), about 12 L_{g}/min/(380 L_{w}), about 13 L_{g}/min/(380 L_{w}), about 14 L_{g}/min/(380 L_{w}), about 15 L_{g}/min/(380 L_{w}), about 16 L_{g}/min/(380 L_{w}), about 17 L_{g}/min/(380 L_{w}), about 18 L_{g}/min/(380 L_{w}), about 19 L_{g}/min/(380 L_{w}), or about 20 L_{g}/min/(380 L_{w}).

In some embodiments, the aquaculture water is contacted with the treated oxygen-containing gas prior to stocking shrimp or prawns into the aquaculture water.

In some embodiments, the aquaculture water is contacted with the treated oxygen-containing gas following stocking shrimp or prawns into the aquaculture water.

In some embodiments, the aquaculture water is contacted prior to and following stocking shrimp or prawns into the aquaculture water.

In still some other embodiments, the treatment method disclosed herein is stopped prior to harvesting the shrimp or prawns.

In still some other embodiments, the treatment method disclosed herein is stopped at the time of harvesting the shrimp or prawns.

In some embodiments, the treatment method includes a glass media filter for removing or reducing suspended solids. The suspended solids can include dead bacteria. Moreover, the glass media filter may help to prevent infestation of water with bacteria of the species of Vibrio.

Embodiments of the water treatment method disclosed herein can include contacting the aquaculture water with the treated oxygen-containing gas up-stream, down-stream, in parallel, or combination thereof with one or more of a cavitation device, a reverse osmosis device, a filtration device and a flocculation system.

### TERMINOLOGY

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning “either or both.”

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct connection between the identified elements, components, or objects. Often the manner of the coupling will be related specifically to the manner in which the two coupled elements interact.

The term “approximately,” as used in this specification and appended claims, refers to plus or minus 10% of the value given. For example: “approximately 14.0 watts” means a range from 12.6 watts to 15.4 watts.

The term “about,” as used in this specification and appended claims, refers to plus or minus 20% of the value given.

The terms “biologically contaminated” and “biologically contaminated water,” as used in this specification and appended claims, generally refers to water containing bacterial matter and, thereby, generally rendering the water unsuitable for its intended purpose. The terms “Heterotrophic Plate Count” or “HPC” generally include bacteria such as: species of Vibrio, including but not limited to Vibrio parahaemolyticus, Vibrio harveyi, Vibrio campbelli, Vibrio owensii and Vibrio cholerae. The HPC bacteria are considered to be opportunistic pathogens for shrimp. The terms “polluted” or “polluted water” refers to water that is unfit or undesirable for its intended use. Thus water that is intended to be used as aquaculture may be polluted.

The term “aquaculture” as used in this specification and appended claims, generally refers to aquatic farming of crustaceans. Crustaceans include shrimp, such as Penaeus vannamei. Particular kinds of aquaculture include shrimp farming and prawn farming. Aquaculture systems can include sealed aerated ponds as well as marine environments.

The term “oxygenated gas,” as used in this specification and appended claims, refers to a gas phase mixture or solution comprising some form of oxygen at a level of at least 1% by weight. Forms of oxygen include monoatomic oxygen (O); diatomic oxygen, also known as ground state (triplet, 3Σ_{g}⁻O₂) molecular oxygen (O₂); ozone or triatomic oxygen (O₃); diatomic oxygen with electrons in either of two excited states (¹Δ_{g}⁻O₂ and ¹Σ_{g} O₂) known as singlet oxygen (either form of singlet oxygen represented here as ¹O₂); and superoxide anion (O₂⁻).

The term “air,” as used in this specification and appended claims, refers to the commonly recognized gas that surrounds the surface of the earth and comprises approximately 78.08% N₂, 20.95% O₂, 0.934% Ar, and 0.0383% CO₂ by volume using the 1976 Standard Atmosphere values at sea level.

The term “oxygen supplemented air,” as used in this specification and appended claims, refers to air comprising greater than 21.1% O₂ by weight.

The term “ozone fortified gas,” as used in this specification and appended claims, refers to a gas comprising greater than 600 parts per billion ozone.

The term “ozone fortified air,” as used in this specification and appended claims, refers to air comprising greater than 600 parts per billion ozone.

The term “ultraviolet radiation” or “UV radiation,” as used in this specification and appended claims, refers to electromagnetic radiation having wavelength in a range from 40 nm to 400 nm. Accordingly, a UV radiation source emits electromagnetic radiation having wavelength in a range from 40 nm to 400 nm.

The term “substantially UV transmissive” or “substantially UV transmissive material,” as used in this specification and appended claims, refers to material that transmits 50% or more of radiation having a wavelength of about 180 nm and/or about 254 nm, per 1 mm of material.

The term “substantially parallel,” as used in this specification and appended claims, refers to lines or axes are relative to one another plus or minus 3°.

### Embodiments of Water Treatment Devices

One or more of the water treatment devices described herein below as well as in U.S. Pat. No. 8,361,384 and U.S. Patent Application Publication Nos. 2013/0087504 and 2012/0261349, each of which is incorporated herein by reference, can be used to form the treated oxygen-containing gas stream.

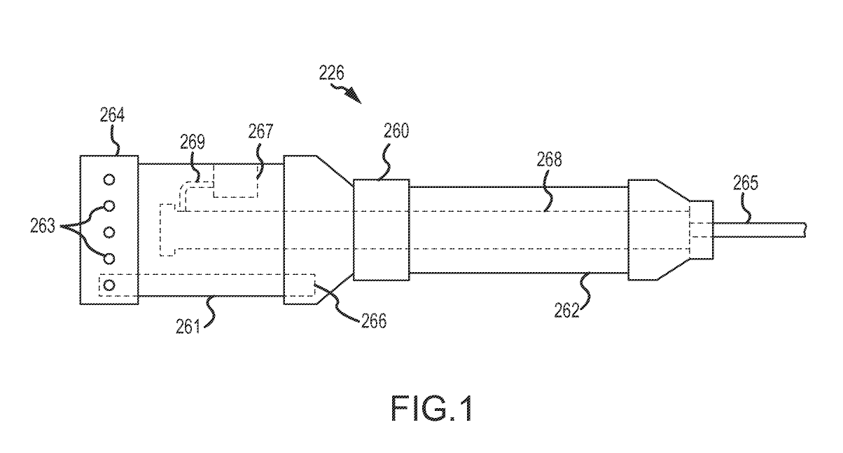

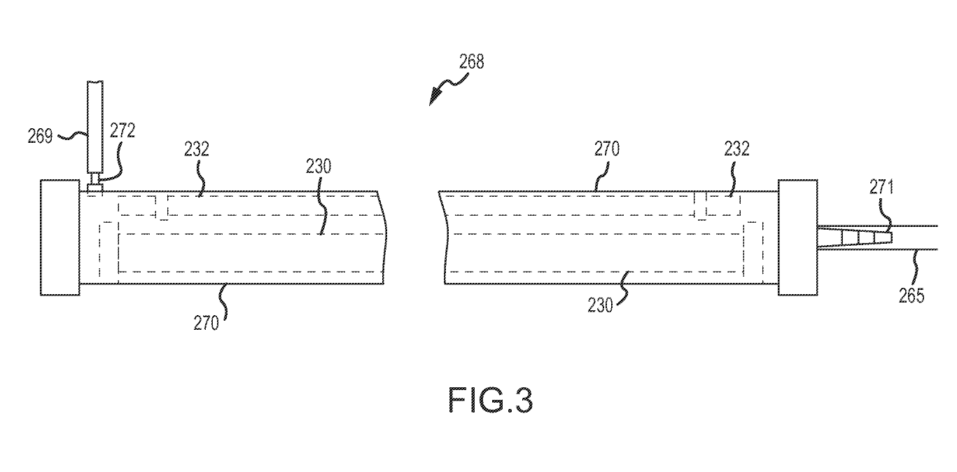

A first embodiment of suitable water treatment device 226 comprises a housing 260 within which reside a ballast 266, an electric gas pump 267, and a gas treatment chamber 268 (FIG. 1). The ballast is a universal B224PWUV-C ballast, and is used to power a UV radiation source (not shown in FIG. 1, shown as element 230 in FIG. 3) that resides in the gas treatment chamber.

The electric gas pump of the second embodiment water treatment device is a Tetra Whisper® 150 aquarium air pump. The electric gas pump delivers air under positive pressure to the gas treatment chamber through a fluid delivery tube 269 at a flow rate of at least 28 liters per hour (L/hr). Flow rates of 300 L/hr or greater may be required for some applications. A barbed fitting 272 penetrates the chamber housing 270 and allows gas to enter the gas treatment chamber from the fluid delivery tube. A fluid exit port 271 is adapted to allow gas under positive pressure to exit the water treatment device, whereupon treated gas typically flows into water in a water system. Except for the barbed fitting and the fluid exit port, the gas treatment chamber is substantially gas tight.

The gas treatment chamber 268 also houses a magnetic rod (not shown in FIG. 1, shown as element 232 in FIG. 3). The housing 260 further comprises gas inlet ports 263 that reside in a removable access cap 264. The water treatment device 226 further comprises a gas outlet tube 265. In typical operation, air is pumped from within the housing, through the gas treatment chamber 268, and out the gas outlet tube 265. As air is removed from the water treatment device by flowing out the gas outlet tube 265, it is replaced by outside air that inters the housing through the gas inlet ports 263.

In accordance with at least some embodiments, the housing 260 is approximately 40 inches long, and comprises a butt portion 261 and an aft portion 262. The housing 260 can be formed from a polyvinyl chloride (PVC) material. In other embodiments, the housing and gas treatment chamber include materials such as, but not limited to, metal, metal alloys, composites, and natural and synthetic polymers. The butt portion 261 can comprise a cylindrical PVC tube approximately 14 inches long and having an inside diameter of approximately six inches. The aft portion 262 can comprise a PVC tube approximately 26 inches long and having an inside diameter of approximately 4 inches.

The gas treatment chamber 268 comprises a chamber housing 270, the chamber housing can include acetonitrile butadiene styrene (ABS) tube approximately 36 inches long with an inside diameter of approximately 1.5 inches. The UV radiation source 230 resides in the gas treatment chamber. As an example, the UV radiation source can comprise a model G36T5VH/4P ozone producing quartz UV lamp from Ushio America, Inc. (Cypress, Calif.). The model G36T5VH/4P lamp operates at approximately forty (40) watts power consumption and has a main spectral peak at approximately 253.7 nm and another spectral peak at approximately 180 nm. The UV lamp is generally elongate and cylindrical, having a length of about 33 inches and a diameter of about 0.6 inches. It consumes approximately forty (40) watts power and emits approximately fourteen (14) watts power in the form of ultraviolet radiation. As is known to persons of ordinary skill in the art, radiation having a wavelength around 254 nm is highly antimicrobial. Similarly, radiation having a wavelength around 180 nm generates ozone in air, albeit inefficiently relative to corona discharge.

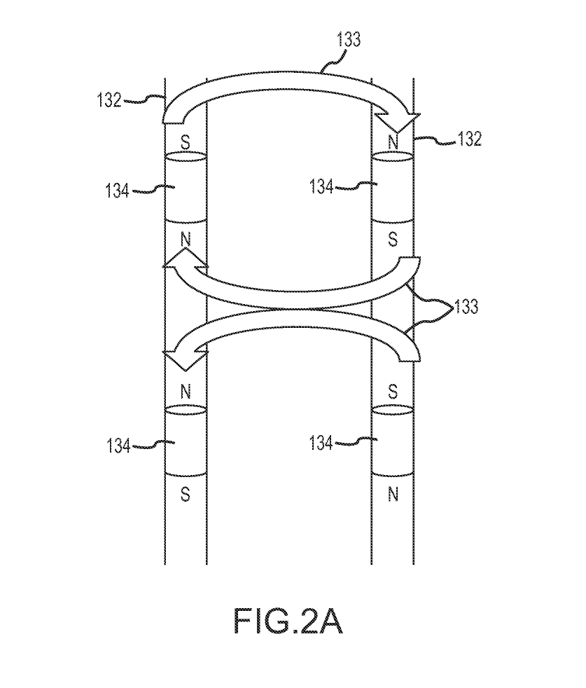

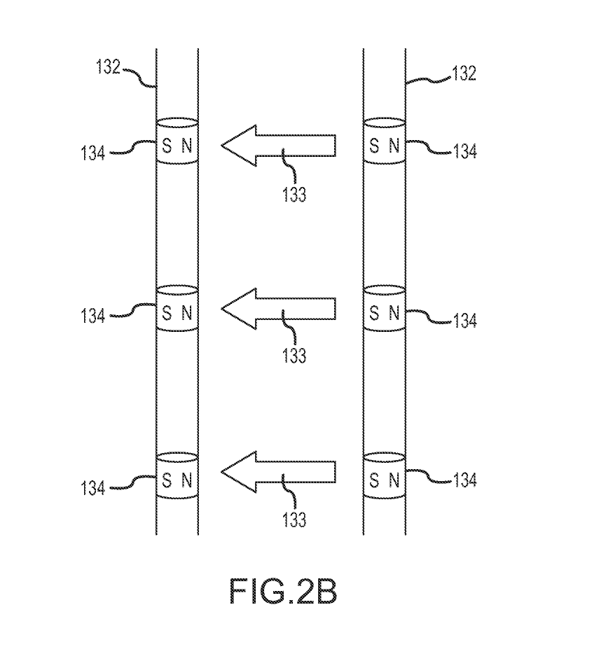

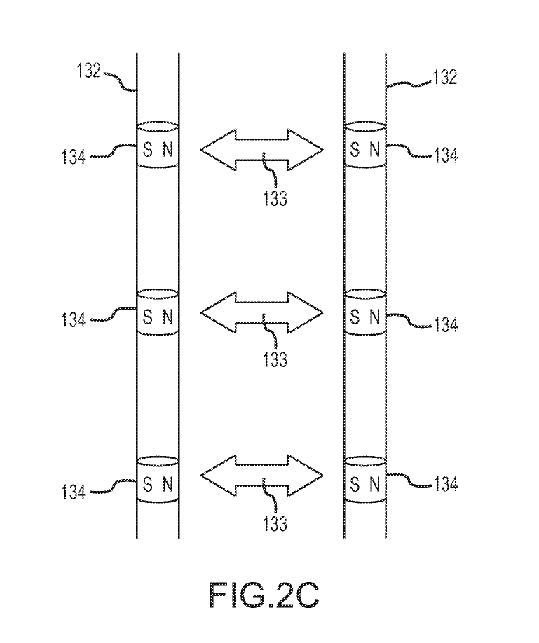

One or more magnetic rods 232 also reside within the gas treatment chamber 268. The magnetic rods can comprise a non-magnetic tube within which resides two or more permanent magnets (not shown). The non-magnetic tube may comprise an organic polymeric material or a non-magnetic metallic material. The magnets of the magnetic rod 232 may be cylindrically shaped neodymium (Neodymium-Iron-Boron) grade N52 magnets, each magnet having a cylinder diameter of approximately 0.50 inch and a cylinder height of approximately 0.50 inch. The magnets of the second embodiment are rare earth magnets. Other embodiments use other rare earth magnets such as samarium-cobalt magnets. The non-magnetic tube has an inside diameter of approximately 0.50 inch. The magnets and the one or more magnetic rods 232 may be arranged in any of the arrangements depicted in FIGS. 2A-2C.

Except for the barbed fitting 272 and the fluid exit port 271, the gas treatment chamber is substantially gas tight. Accordingly, air or other gas pumped into the gas treatment chamber through the barbed fitting can only exit the chamber through the fluid exit port. Apertures in the gas treatment chamber through which wires enter the chamber in order to supply electricity to the UV lamp are well sealed in order to maintain a substantially gas tight chamber.

Wiring of electrically powered components such as the ballast, air pump, and UV radiation source is not shown in the figures. However, persons of ordinary skill in the art recognize that the ballast is wired to the UV lamp, and that the water treatment device is electrically coupled to a source of electric power in order to operate. Typical electrical coupling includes, but is not limited to, plugging into an electrical outlet or hard-wiring.

The second embodiment water treatment device 226 is merely exemplary. Other embodiments comprise other UV radiation sources, including, but not limited to, other UV lamps, lasers, or diodes adapted to emit radiation in the ultraviolet range. Some embodiments do not require a ballast, or use a different ballast than the B224PWUV-C. Non-limiting examples of suitable lamps include arc, discharge (including noble gas, sodium vapor, mercury vapor, metal-halide vapor or xenon vapor), induction, plasma, low-pressure, high-pressure, incandescent and discharge lamps emitting ultra-violet radiation having suitable wavelengths. Examples of suitable lasers without limitation, include gas, chemical, excimer, solid-state, fiber, photonic, semi-conductor, dye or free-electron laser operate in one of continuous or pulsed form. Furthermore, suitable diodes include without limitation diamond, boron nitride, aluminum nitride, aluminum gallium nitride, and aluminum gallium, indium nitride. The water treatment device 262 may or may not be coated on the inside with a UV reflective coating. Moreover, the water treatment device 262 may be configured to focus the UV radiation emitted from the UV radiation source on the gas treatment chamber 268. For example, the water treatment device 262 can have a shape resembling an ellipse, with the gas treatment chamber 268 substantially positioned at a focal-point of the ellipse.

In some embodiments, the UV radiation source or the magnets reside outside the gas treatment chamber. Where the UV radiation source resides outside the gas treatment chamber, the chamber housing should permit transmission of substantial amounts of UV light into the gas treatment chamber. For example, a glass tube comprising GE Type 214 fused quartz glass is an appropriate gas treatment chamber housing where the UV radiation source resides outside the gas treatment chamber.

A water treatment system 300 incorporating a water treatment device 326 in accordance with further embodiments of the present disclosure is illustrated in FIG. 5 In this embodiment, the water treatment device 326 provides a treated gas to control, reduce, or both control and reduce levels of Vibrio species contained in an aquaculture water 808. The treated gas can comprise an oxygen containing gas such as air from the ambient environment that has been exposed to ultraviolet radiation in a treatment chamber, and that is then introduced to the aquaculture water 808. In accordance with further embodiments, the treated gas can comprise air that has been exposed to ultraviolet radiation in the presence of a magnetic field within a treatment chamber, and that treated gas can then be introduced to the aquaculture water 808. In the illustrated embodiment, the water treatment device 326 is interconnected to a branch circuit or line of the aquaculture water 808. The aquaculture water 808 can comprise any aquaculture water containing bacteria of the species of Vibrio and combinations thereof. In addition, although shown as being connected to a branch circuit or line 804, the treated gas produced by a water treatment device 326 in accordance with embodiments of the present invention can be introduced directly to the aquaculture water 808.

The water treatment device 326 generally includes at least one treatment chamber 816 that contains a UV radiation source. In addition, the treatment chamber 816 can house one or more magnets, configured in one or more arrays. An oxygen gas, such as ambient air, is introduced by an inlet 824 to the treatment chamber 816, for example by a pump 828 or other source of pressurized gas. After exposure to the UV radiation, and optionally to the magnetic field, the treated gas exits the treatment chamber 816 through an outlet 852, and is introduced to the water contained within the aquaculture water 808.

A water treatment device 326 can include any number of treatment chambers 816, for example to scale the water treatment device 326 such that an appropriate amount of treated gas can be provided to the aquaculture water 808 to be treated. The water treatment device 326 in the exemplary embodiment of FIG. 5 includes multiple treatment chambers 816. In particular, first 816a and second 816b treatment chambers are illustrated. The treatment chambers 816 are mounted to a common frame or support structure 820. Each treatment chamber 816 includes an inlet 824 that is supplied with pressurized air by a pump 828. More particularly, an outlet 832 of the pump 828 can be connected to a common supply conduit 836. The common supply conduit 836 can in turn be connected to a Y or T fitting 840 via a solenoid valve 844. First 848a and second 848b supply conduits are interconnected to the first 824a and second 824b inlets of the treatment chambers 816a and 816b respectively. In accordance with embodiments of the present disclosure, the pump 828 draws air from the ambient environment, and provides a pressurized supply of such air to the treatment chambers 816. The solenoid valve 844 allows the interior volumes of the treatment chambers 816 to be sealed off while the pump 828 is not supplying pressurized air, for example as a result of a planned or inadvertent shutdown of the pump 828, to prevent a backflow of aquaculture water 808 into the water treatment device 326.

Each treatment chamber 816 includes an outlet 852. Each outlet 852 can be interconnected to a corresponding outlet conduit 856a or 856b. A common outlet conduit 860 is in turn interconnected to the outlet conduits 856a and 856b by a Y or T fitting 864. The common outlet conduit 860 is in turn interconnected to the branch circuit 804 at an injection port 868.

Accordingly, pressurized air that is passed through a treatment chamber 816 is supplied to the aquaculture water 808 within the branch circuit 804 as a treated gas via the injection port 868. In accordance with at least some embodiments, the injection port 868 can comprise a simple T fitting, a bubbler, a venturi, or the like. Alternatively or in addition, the injection port 868 can incorporate or be associated with a one-way valve that allows treated gas to enter the aquaculture water, but to prevent the aquaculture water from entering the outlet conduit 860. Moreover, the injection port 868 can incorporate or be associated with a viewing port, for example to allow maintenance personnel to confirm operation of the device by inspection.

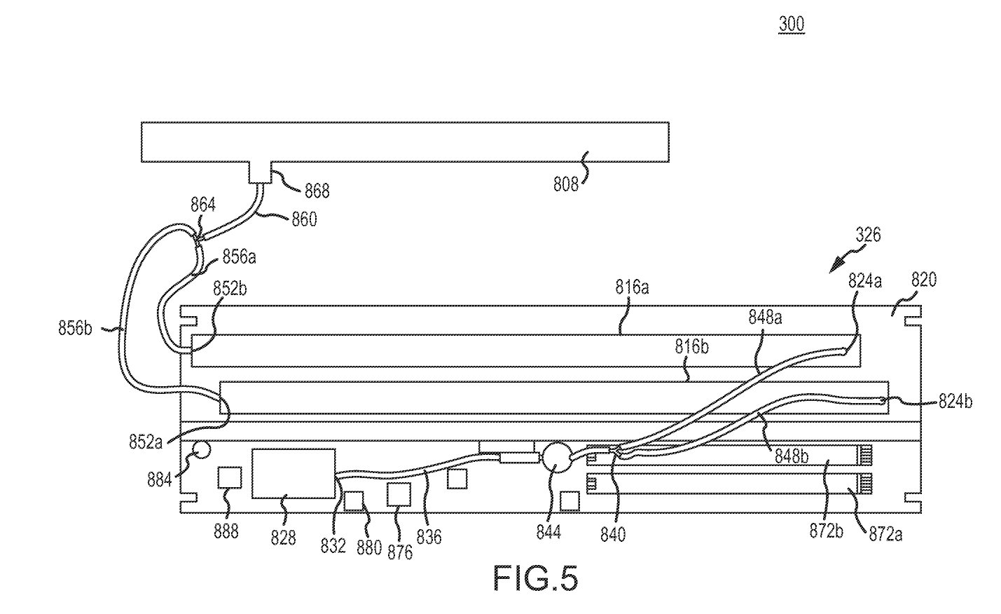

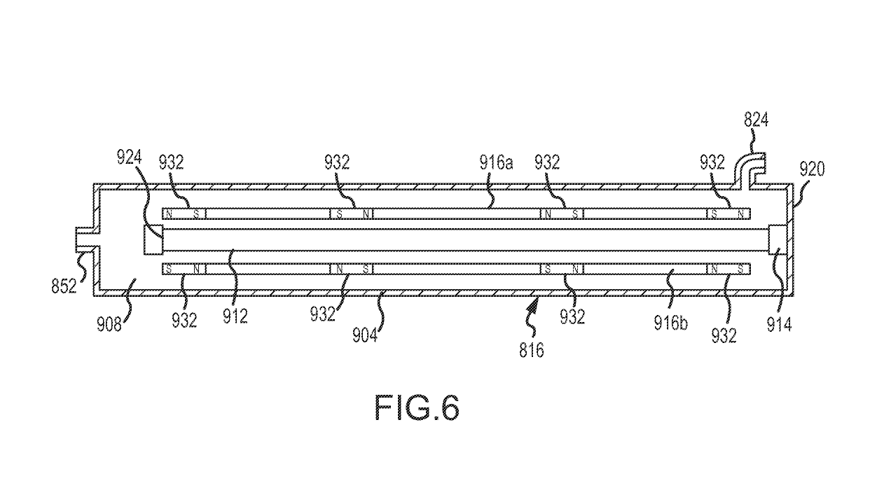

The water treatment device 326 also includes various electronic components. For example, a ballast 872 (depicted as 872a and 872b) is provided to supply a controlled current to the UV radiation or light source 912 (see FIG. 6) within each treatment chamber 816. In the example illustrated in FIG. 5, a first ballast 872a is provided to supply current to the UV radiation source 912 of the first treatment chamber 816a, while a second ballast 872b is provided to supply a controlled current to the UV radiation source 912 of the second treatment chamber 816b. In addition, one or more controller boards 876 may be provided. The controller board 876 can include a processor and associated memory to control aspects of the operation of the water treatment device 326. For example, operation of the pump 828, the solenoid 844, and the UV radiation sources 912 can be under the control of the controller board 876. The controller board 876 can also receive control input, for example from a user through an associated user input device 880 regarding the operation of the water treatment device 326. Moreover, the controller board 876 can provide output to a user output device 884 concerning the operation of the water treatment device 326. In an exemplary embodiment, the controller board 876 may comprise a controller device with an integrated processor and memory. Alternatively or in addition, the controller board 876 can include discrete digital logic devices and/or analog devices. Embodiments of a water treatment device 326 can additionally include various gages and/or indicator lamps 888. The gages and indicator lamps 888 can include indications of the amount of current being drawn by one or more of the UV radiation sources 912, to provide an indication of the proper operation of the UV radiation source 912. As a further example, a gage or indicator lamp 888 can provide indication of the air pressure within a treatment chamber 816, to provide information regarding the operation of the pump 828.

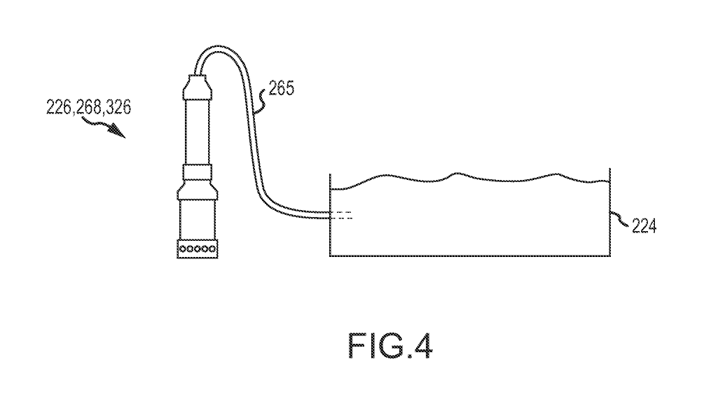

FIG. 4 illustrates the water treatment devices 226, 268 and/or 300 connected to an aquaculture water system 224 to be treated.

A water treatment device 226, 268 or 300 is operationally coupled to the aquaculture water system 224 through a gas outlet tube 265. The aquaculture water system 224 is in fluid communication with the water treatment device (226, 268 and 300) through the gas outlet tube 265. In typical operation, the water treatment device delivers treated gas to the aquaculture water system 224 through the gas outlet tube, and the water in the aquaculture water system 224 does not enter the water treatment device (226, 268 and 300). The treated gas is typically, but not necessarily, air.

FIG. 6 is a cross-section of a treatment chamber 816 in accordance with embodiments of the present disclosure. The treatment chamber 816 includes a treatment chamber housing 904. The treatment chamber housing 904 includes a treatment chamber input port or inlet 824 and a treatment chamber output port or outlet 852. The treatment chamber housing 904 additionally defines an interior or treatment volume 908. Moreover, the input port 824 and the output port 852 are generally at opposite ends of the treatment chamber housing 904 and the interior volume 908 defined therein. An ultraviolet (UV) radiation or light source 912 is located within the interior volume 908 of the treatment chamber housing 904. The UV radiation source 912 can comprise a low pressure mercury lamp that produces light at germicidal (e.g., about 254 nm) and ozone producing (e.g., about 180 nm) wavelengths. Moreover, the UV radiation source 912 can, in an exemplary embodiment, but without limitation, comprise a four pin single ended device, with the pins or electrical contacts located in a base portion 914 at a first end 920 of the treatment chamber housing 904. As can be appreciated by one of skill in the art, in a single ended lamp, the power is supplied to an electrode or electrodes at the second end 924 of the lamp by wires (not shown) that extend from the first end 920 to the second end 924 of the lamp. In accordance with still other embodiments, the UV radiation source 912 can comprise any source of radiation at the desired wavelength or wavelengths. For example, a UV radiation source 912 can comprise one or more lasers tuned or otherwise configured to output a desired wavelength or wavelengths.

The treatment chamber 816 can also include a pair of linear arrays 916 of magnets 932. The magnets 932 can be arranged such that the polarities of the individual magnets 932 within an array 916 repel one another. In addition, as between the two arrays 916a and 916b, adjacent magnets 932 are arranged such that their magnetic fields are oppositely aligned. Alternatively, the magnets 932 can be arranged such that the polarities of the individual magnets 932 with the array 916 attract one another. In addition, as between the two arrays 916a and 916b, adjacent magnets 932 are arranged such that their magnetic fields similarly aligned.

As a result, magnetic fields that traverse at least some or a substantial portion of the interior volume 908 of the treatment chamber 816 are created. Depending upon the arrangement of magnets 932 within the individual arrays 916a and 916b and the arrangement of arrays 916a relative to 916b, the magnetic fields may be substantially attractive (that is, substantially between magnetic North and South poles) or substantially non-attractive (that is, substantially between one of magnetic North poles or one of magnetic South poles).

Accordingly, air introduced at the inlet 824 and exhausted through the outlet 852 is passed through the magnetic fields, as well as being exposed to UV radiation from the UV radiation source 912. The UV radiation source 912 can be any electromagnetic source providing electromagnetic radiation having wavelengths of one or both of 180 and 254 nm. It can be appreciated that the UV radiation source 912 can, in addition to one or both of 180 and 254 nm wavelengths, provide electromagnetic radiation of other wavelengths. The UV radiation source 912 can be electromagnet energy provided by diodes, the sun or any other source capable of producing electromagnetic energy of one or both of 180 and 254 nm.

The electromagnetic energy can be focused and/or directed in the chamber 816 by one or more of reflective surfaces, transparent surfaces, lenses, light pipes, combinations thereof or such. Furthermore, the air may be exposed to thermal energy as well as UV radiation. The exposure to the thermal energy may raise or lower the temperature of the air. A thermal energy source may be used in place of UV radiation source 912.

In accordance with alternate embodiments, the magnets 932 within an array 916 can be arranged such that they attract one another. In accordance with still further embodiments, magnets can be placed next to the ends of the UV radiation source 912. For example, a pair of magnets 932 (such as depicted in FIGS. 2A-2C), aligned such that their magnetic fields are opposite one another, can be placed next to each end of the UV radiation source 912. The magnets 932 can comprise permanent magnets, including but not limited to high strength permanent magnets. Alternatively or in addition, the magnets 932 can comprise electromagnets. In accordance with still other embodiments, magnets 932 can be located outside of the treatment chamber 816, but positioned such that the magnetic field or fields produced by the magnets 932 intersect gas to be treated and which will subsequently be provided to the aquaculture water.

As can be appreciated by one of skill in the art after consideration of the present disclosure, a water treatment device 326 can be scaled to incorporate any number of treatment chambers 816. For example, a single treatment chamber 816 version can be provided by omitting the second treatment chamber 816b, and by likewise omitting the associated conduits 848b and 852b and the corresponding Ts 840 and 864, or alternatively by capping or plugging the third port of the T's 840 and 864. As yet another alternative, a water treatment device 326 can incorporate more than two treatment chambers 816, by providing additional treatment chambers 816, and through appropriate interconnections of the inlets 824 of such chambers 816 to the pump 828, and between the outlets 852 of such chambers and the injection port 868. In accordance with still other embodiments, a water treatment device 326 can be provided with multiple treatment chambers 816, in which less than all of the treatment chambers 816 are operated. For example, additional treatment chambers 816 can be incorporated as spares, and can be interconnected to the pump 828 and the injection port 868 after the failure of another one of the treatment chambers 816. In accordance with still other embodiments, a water treatment device 326 with multiple treatment chambers 816 can be provided in which all of the included treatment chambers 816 are interconnected to the pump 828 and/or oxygen concentrator and to the injection port 868, but in which a selected number of UV radiation sources 912 associated with treatment chambers 816 are operated at any particular point in time. Further in accordance with still other embodiments, the water treatment device 326 may include a gas humidifier or a gas de-humidifier to supply, respectively, one of humidified or de-humidified gas to the treatment chambers 816. Such embodiments permit higher concentrations of treated gas to be supplied to the injection port 868 when required, by operating all or a greater number of the treatment chambers 816, for example upon startup of the water treatment device 326 or when aggressive treatment of the aquaculture water 808 within the water treatment system 300 is desired. When a steady state or when aggressive treatment of the aquaculture water 808 is otherwise not required, at least some of the UV radiation sources 912 can be powered off, to conserve electrical power.

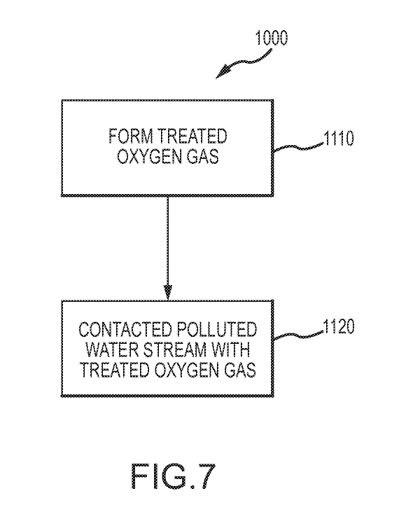

FIG. 7 depicts a process 1000 for treating an aquaculture water 808 in accordance with some embodiments of the present disclosure.

In step 1110, an oxygen-containing gas stream is contacted with ultraviolet radiation to form treated oxygen-containing gas. Preferably, the oxygen-containing gas stream comprises air. The air can be derived from any source, such as without limitation the surrounding atmosphere, a compressor, an air pump, or a gas cylinder containing compressed air to name a few. In some configurations, the oxygen-containing gas stream can comprise an oxygen fortified air or a super-atmospheric oxygen gas stream. Oxygen fortified air generally refers to gas stream containing more than about 21.1% oxygen (O₂) (according to the 1976 Standard Atmosphere) and nitrogen (N₂), argon (Ar) and carbon dioxide (CO₂) in volume ratio of about 78:1:0.04. At least some of the oxygen contained in the oxygen-fortified air can be derived from an oxygen concentrator, an oxygen-generator, an oxygen source (such as without limitation, bottled oxygen gas or liquid oxygen source), or a combination thereof. A super-atmospheric oxygen gas stream generally refers a gas stream having a partial pressure of oxygen greater than the ambient oxygen partial pressure. The supper-atmospheric oxygen gas stream may or may not contain one or more of nitrogen, argon and carbon dioxide and may or may not have a nitrogen:argon:carbon dioxide volume ratio of about 78:1:0.04.

The ultraviolet radiation can be derived from any process and/or device generating ultraviolet electromagnetic radiation. Preferably, the oxygen-containing gas stream absorbs at least some the ultraviolet radiation to form the treated oxygen-containing gas. More preferably, at least some of the oxygen absorbs at least some of the ultraviolet radiation to form the treated oxygen-containing gas. In some configurations, the oxygen-containing gas stream is contacted with the ultraviolet radiation in the presence of a magnetic field.

The magnetic field is generated by a linear array of magnets. The magnets are preferably permanent magnets, but in some configurations can be electromagnets.

The ultraviolet radiation has a wavelength from about 40 to about 400 nm. Preferably, the ultraviolet radiation comprises radiation having a wavelength of about 180 nm, about 254 nm, or a mixture of 180 and 254 nm wavelengths.

While not wanting to be limited by theory, it is believed that the treated oxygen-containing gas comprises one or more of oxygen atoms, oxygen radicals and hydroxyl radicals. The absorption of ultraviolet radiation by oxygen (O₂) is believed to cause some of the oxygen (O₂) to dissociate into oxygen atoms (O). The oxygen atoms (O) are believe to be neutral, that is uncharged, oxygen radials.

In step 1120, an aquaculture water is contacted with the treated oxygen-containing gas to form a treated aquaculture water. In some configurations, the aquaculture water has a first concentration of bacteria of the species Vibrio and the treated water has a second concentration of the bacteria of the species Vibrio. Preferably, the second concentration is no more than the first concentration. It is believed that the contacting of treated oxygen-containing gas with the aquaculture water kills at least some of the bacteria of the species Vibrio. More specifically, it is believed that the bacteria of the species Vibrio are killed by the contacting of the one or more of the oxygen atoms, oxygen radicals and hydroxyl radicals contained in the treated oxygen-containing gas with the aquaculture water.

In a method of treating aquaculture water by use of a water treatment device of the present invention, the electric gas pump of at least some embodiments of the water treatment device draws air from within the housing of the water treatment device and pumps the air under positive pressure through the fluid delivery tube. The air flows across a pressure gradient into the gas treatment chamber, where the air is subjected to UV radiation while proximate a magnet residing in the magnetic rod. The gas is preferably UV irradiated while within 8 inches of the magnet, more preferably within 3 inches of the magnet, still more preferably within 1.5 inch of the magnet, and most preferably within 0.5 inch of the magnet. The UV radiation is emitted by the UV radiation source. The UV radiation source of the second embodiment water treatment device emits radiation having spectral peaks with wavelengths of approximately 253.7 nm and 180 nm.

As used here, even lasers and diodes can emit radiation having spectral peaks, although the spectrum or spectrums of radiation may be very narrow. Persons of ordinary skill in the art recognize that even radiation referred to as monochromatic usually emits wavelengths across a spectrum, albeit a very narrow one. Where a UV radiation source emits radiation of only one wavelength, that wavelength is considered a spectral peak for the purposes of this specification and appended claims.

Ozone can be generated in the air as it flows through and is treated in the gas treatment chamber. The treated air exits the gas treatment chamber into the gas outlet tube and then into the aquaculture water. Air that exits the water treatment device by flowing into the gas outlet tube is replaced by air flowing into the housing through gas inlet ports disposed in the water treatment device housing.

Treated air refers to air that has been irradiated by UV light from the UV radiation source in the presence of a magnetic field generated by the magnets. In the some embodiments of the water treatment device, the magnets are permanent magnets. In some other embodiments, the magnets can be electromagnets. In accordance with still other embodiments, a combination of electromagnets and permanent magnets can be included. Moreover, where permanent magnets are used, those magnets can comprise high strength magnets. Air that exits the water treatment device by flowing into the gas outlet tube is replaced by air flowing into the housing through gas inlet ports.

While not wanting to be limited by any particular example, the presence and orientation of magnetic fields within the treatment chamber when oxygen-containing gas is exposed to ultraviolet light can affect the level of hydrogen peroxide in the treated water. Table I summarizes the effect that a magnetic field can have on the level of hydrogen peroxide in the treated water. In Test No. 1, a 20-gallon sample of water was exposed for 20 minutes to

TABLE I

| Test No. | Magnetic Configuration | Level of H₂O₂ in Treated Water |
|---|---|---|
| 1 | No Magnetic Field | 0.2 ppm |
| 2 | (NS)(NS)(NS)(NS) | 1.0 ppm |
| 3 | (NS)(SN)(NS)(SN) | 4.0 ppm |

an oxygen-containing gas treated with ultra-violet light in the absence of an applied magnetic field. At the conclusion of Test No. 1, the treated water had a hydrogen peroxide level of about 0.2 ppm. In Test No. 2, a fresh 20-gallon sample of water was exposed for 20 minutes to an oxygen-containing gas treated with ultra-violet light in the presence of an attractive magnetic field. The attractive magnetic field is formed from a series of magnets having their magnetic poles aligned in an attractive manner, that is (NS)(NS)(NS)(NS). The water treated with oxygen-containing gas radiated with ultra-violet light in the presence of the attractive magnetic field had a hydrogen peroxide level of about 1.0 ppm at the conclusion of Test No. 2, about five times that of the water treated in the absence of an applied magnetic field. In Test No. 3, a fresh 20-gallon sample of water was exposed for 20 minutes to an oxygen-containing gas treated with ultra-violet light in the presence of an opposing magnetic field. The opposing magnetic field is formed from a series of magnets having their magnetic poles aligned in an opposing manner, that is (NS)(SN)(NS)(SN). Water treated with oxygen-containing gas radiated with ultra-violet light in the presence of the opposing magnetic field had a hydrogen peroxide level of about 4.0 ppm at the conclusion of Test No. 3. This is about twenty times that of water treated in the absence of an applied magnetic field and about four times that of water treated with an applied attractive magnetic field.

Each publication or patent cited herein is incorporated herein by reference in its entirety. The invention now being generally described will be more readily understood by reference to the following examples, which are included merely for the purposes of illustration of certain aspects of the embodiments of the present invention. The examples are not intended to limit the invention, as one of skill in the art would recognize from the above teachings and the following examples that other techniques and methods can satisfy the claims and can be employed without departing from the scope of the claimed invention.

### EXAMPLES

### Example 1

This example demonstrates that the water treatment method disclosed herein, is successful at controlling and/or reducing the level Vibrio parahaemolyticus VP-A/3 in a short period of time without leaving harmful residues that are known to kill shrimp (such as Penaeus vannamei), thus enhancing shrimp survival. The treatment thus is shown to reduce Early mortality syndrome (also known as Acute hepatopancreatic necrosis disease or AHPND) in the shrimp, which has been shown to be caused by Vibrio parahaemolyticus VP-A/3. While not wanting to be bound by any theory, it is believed that the level of treated oxygen-containing gas generated by passing an oxygen-containing gas stream through ultra-violet radiation in a magnetic field, as described in the water treatment methods disclosed herein is sufficient to kill the Vibrio parahaemolyticus (VP-A/3), thus controlling and/or reducing the level or amount of this bacteria in a short period of time without leaving harmful residues that would kill the shrimp.

### Aquaria and Design

Three 90 L tanks (i.e. vessels) were used. Each one of these tanks was filled up with 60 L of artificial seawater (pre-mixed Crystal Sea Marine Mix, Marine Enterprises International). Salinity was adjusted to about 20 ppt, and each tank was provided with adequate aeration. The three experimental tanks (designated as A, B, and C) were inoculated with Vibrio parahaemolyticus A/3 (VP-A/3—the isolate previously shown to cause EMS/AHPNS) at optical density (OD) readings of about 10⁴, 10⁵ and 10⁶ colony forming units/ml (CFU/ml) respectively. The actual amount of bacteria added to each one of the tanks was measured using the total plate count (TPC) method using Trypticase Soy Agar plus 2% NaCl (TSA+). To accurately determine the number of colony forming units (CFU) per mL of tank water for each bacterial concentration tested, a dilution series of 1 mL into 100 mL of sterile artificial seawater was performed. After the three experimental tanks had been inoculated with the VP-A/3 isolate, treated oxygen-containing gas that is generated by the device disclosed herein and detailed below, was injected into each tank via a diffuser at 2 L/min for a time period of 15 seconds (Dose 1) followed by a second injection for 45 seconds (Dose 2) at 2 L/min.

As disclosed herein, the device used in this example as well as the examples that follow, passes an oxygen-containing gas stream through ultra-violet radiation in a magnetic field, thus generating the oxygen containing gas that is used for treating the bacterial containing water. The device had a single chamber containing a 37 watt lamp. The lamp produced radiation at about 180 and about 254 nanometers, of which about 0.7 watts were of the 180 nanometers and about 36.3 watts of 254 nanometers. Some devices included two 0.75″×0.5″×1.25″ neodymium ring magnets placed 0.25 inches apart with south poles opposing each other directly across the corona of the lamp and perpendicular to the lamp. The neodymium magnets have an residual induction (Bᵣ) from about 12.9 to about 13.3 K Gauss and about 1.29 to about 1.33 Tesla, a minimum coercive force from about 1.5 to about 12.4 K-Oersted and from about 915 to about 987 kA/m, a minimum intrinsic coercive force H_{ci} from about 12 to about 25 K-Oersted and from about 955 to about 1,592 kA/M, and maximum energy product (BH)ₘₐₓ from about 40 to about 43 MGOe and from about 318 to about 342 kJ/m³.

A sample of undiluted water was collected from each tank to determine TPC approximately 3 min after each water treatment. After 24 hours of treatment with the treated oxygen-containing gas generated by passing an oxygen-containing gas stream through ultra-violet radiation in a magnetic field, as described in the water treatment methods disclosed herein, 10 juvenile shrimp (Penaeus vannamei) were stocked into each tank to determine if sufficient VP-A/3 had remained in the water that could still infect the indicator shrimp with EMS/AHPNS. Colony Forming Units (denoted as CFU) is an estimate of viable bacterial numbers.

As further discussed below, all tanks were fed with a commercial pelleted diet and checked twice a day for moribund or dead animals. A sample of moribund animals from each group was preserved in Davidson's Alcohol Formalin Acetic acid (AFA) fixative and processed for routine histology to confirm AHPND infection. All remaining moribund animals and all mortalities were removed from the tanks and frozen. The challenge study was terminated after 7 days (1 day of water treating, 6 days AHPND trial) with all live animals counted as survivors. See Tables II and III for a complete list of results for all tanks included in this study.

Total plate count of the stock bacteria broth culture was 2.8×10⁹ CFU/ml. A volume of stock bacteria of either 0.48 ml, 4.8 ml or 48 ml was added to each one of the Tanks A, B, and C designated as 10⁴, 10⁵, and 10⁶ CFU/ml, respectively. After each injection (i.e. dose) of the treated oxygen-containing gas, as described above, for 15 seconds at 2 L/min and 45 seconds at 2 L/min, undiluted samples from each tank were collected to perform TPC. See Table II for details of TCP in each treatment.

TABLE II
Counts before and after each dose (i.e. injection)
of the treated oxygen-containing gas

| | | | Does 2 |
|---|---|---|---|
| | | Dose 1 | VP-A/3 count |
| | Starting | VP-A/3 count (CFU/ml) | (CFU/ml) |
| | VP-A/3 Count | after 15 sec of | after another 45 |
| Vessels | (CFU/ml) | treatment | sec of treatment |
| A | 22,400 | 19,400 | 8,500 |
| B | 224,000 | 221,000 | 167,000 |
| C | 2,240,000 | 1,960,000 | 1,620,000 |

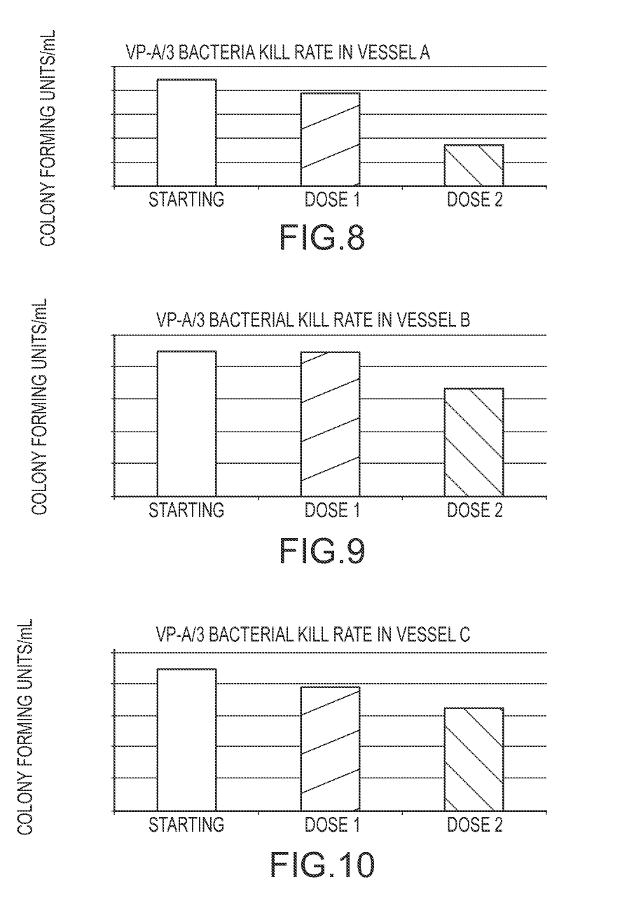

Vessel A (see FIG. 8) started with 22,400 CFU/ml and after both doses of the treated oxygen-containing gas generated as described above, only 8,500 CFU/mL were left. FIG. 8 provides a graphic representation of the starting VP-A/3 bacteria count and the VP-A/3 kill rate after each dose of the treated oxygen-containing gas as described above, showing the reduction of the Vibrio parahaemolyticus VP-A/3 levels by the water treatment method disclosed herein.

Vessel B (see FIG. 9) started with 224,000 CFU/ml and after both doses of the treated oxygen-containing gas generated as described above, only 167,000 CFU/mL were left. FIG. 9 provides a graphic representation of the starting VP-A/3 bacteria count and the VP-A/3 kill rate after each dose of treated oxygen-containing gas disclosed herein.

Vessel C (see FIG. 10) started with 2,240,000 CFU/ml and after both doses of the treated oxygen-containing gas generated as described above, only 1,620,000 CFU/mL were left. FIG. 10 provides a graphic representation of the starting VP-A/3 bacteria count and the VP-A/3 kill rate after each dose of treated oxygen-containing gas disclosed herein.

The results above also demonstrate that treatment with the treated oxygen-containing gas did not kill any shrimp as this would have been evident in the first hour after the shrimp were exposed to the treatment.

### AHPND Challenge Results:

Shrimp mortality rates were then determined. Twenty four hours after the treated oxygen-containing gas treatment doses (i.e. injections) were completed, 10 juvenile shrimp, Penaeus vannamei, were stocked into each vessel to determine if sufficient VP-A/3 had remained in the water that could still cause EMS/AHPNS. The shrimp were left in the vessels for 6 days after treatment. After the 6 day challenge shrimp from each vessel were examined for cause of death. The examination of all shrimp showed that the shrimp were positive for EMS/AHPND.

The first mortalities were noticed in Vessel C (10⁶ CFU/ml) on Day 4 of the challenge study. Ninety percent ( 9/10) of indicator shrimp died on Day 4 of the challenge in Vessel C. Also on Day 4, one moribund shrimp was fixed for later histological examination from Vessel C. Survival rates in Vessel A and Vessel B (treatments of 10⁴ and 10⁵ CFU/ml respectively) were both 90% at termination day (Day 6). On termination day, three survivor shrimp were collected at random from each one of these vessels and fixed for histological examination. Longer periods of treatment dosing, such as 60 seconds at 2 L/min and 120 seconds at 2 L/min can be monitored for an extended period, such as up to 12 days.

After 72 hours all shrimp in vessel C were dead during the treatment study. It is expected that the shrimp would have died within 24 hours in vessel C if no treatment was administered. However, in vessels A and B the treated oxygen-containing gas treatment killed enough VP-A/3 to ensure a survival of 90% of the shrimp after 144 hours and several reproduction cycles of VP-A/3. It is expected that with no treatment in vessel B only 30% of shrimp would have lived within the 144 hours. The water treatment method disclosed herein was instrumental in the higher survival rates and extended shrimp survival.

A complete summary of the histological analysis on samples of L. vannamei luveniles is shown in Table III. This table shows the higher survival rates of shrimp exposed to high levels of the pathogentic bacteria, V. parahaemolyticus, following treatment with the treated oxygen-containing gas generated as described above. Vessel A had 90% survival, whereas shrimp with no treatment had a 30% survival. Vessel B had 90% survival, where shrimp with no treatment usually had 0% survival. Vessel C had 0% survival, where untreated shrimp usually experience the same, however treatment delayed the onset of disease and death by 4 days.

AHPND was found in shrimp from all of the treatments indicating that some VP-A/3 bacteria had remained viable despite the treatment with the treated oxygen-containing gas. However, the fact that the first mortalities in the highest initial bacterial density (Tank C) occurred until Day 4-slower than usual for AHPND suggests that the treated oxygen-containing gas had actually destroyed some of the bacteria. Moreover, the high survival rate observed in Tank A and Tank B at Day 6 also indicates a delaying effect of the treated oxygen-containing gas on the manifestation of the disease.

TABLE III
Survival rates and amount of VP-A/3 in each vessel after 144 hours

| | | Normally | | Normally | |
|---|---|---|---|---|---|
| | With | without | | without | With |
| | Disclosed | Disclosed | With Disclosed | Disclosed | Disclosed |
| | Treatment | Treatment | Treatment | Treatment | Treatment |
| Scenario | Method | Method | Method | Method | Method |
| Vessels | A | | B | | C |
| Time Period of | 144 hours | 144 hours | 144 hours | 24 hours | 72 hours |
| Survival | | | | | |
| Survival Rate | 90% | 30% | 90% | 0% | 0% |
| Starting Density | 2.24 × 10⁴ | 2.24 × 10⁵ | 2.24 × 10⁵ | 2.24 × 10⁶ | 2.24 × 10⁶ |
| of VP-A/3 | | | | | |
| *CFU/mL VP- | 2.95 × 10¹² | 7.77 × 10¹³ | 5.79 × 10¹⁵ | 7.77 × 10¹⁴ | 5.62 × 10¹⁴ |
| A/3 After 6 Days | | | | | |
| of Reproduction | | | | | |

*There were no bacterial counts taken after the water treatment method initial kill rates were determined. All bacterial counts are based upon calculation done for bacterial generations after 6 days or 144 hours of reproduction.

With only 60 seconds at 2 L/min of total exposure (dosing) to the treatment in each vessel, the total kill rate was as follows: Vessel A 13,900 Colony Forming Units/ml; Vessel B 57,000 Colony Forming Units/ml; and Vessel C 620,000 Colony Forming Units/ml. This example clearly shows the tremendous ability of the water treatment system disclosed herein to eliminate VP-A/3 on immediate contact without harming any shrimp. The water treatment system disclosed herein has proven to be an excellent solution to the EMS/AHPND problem

### Example 2

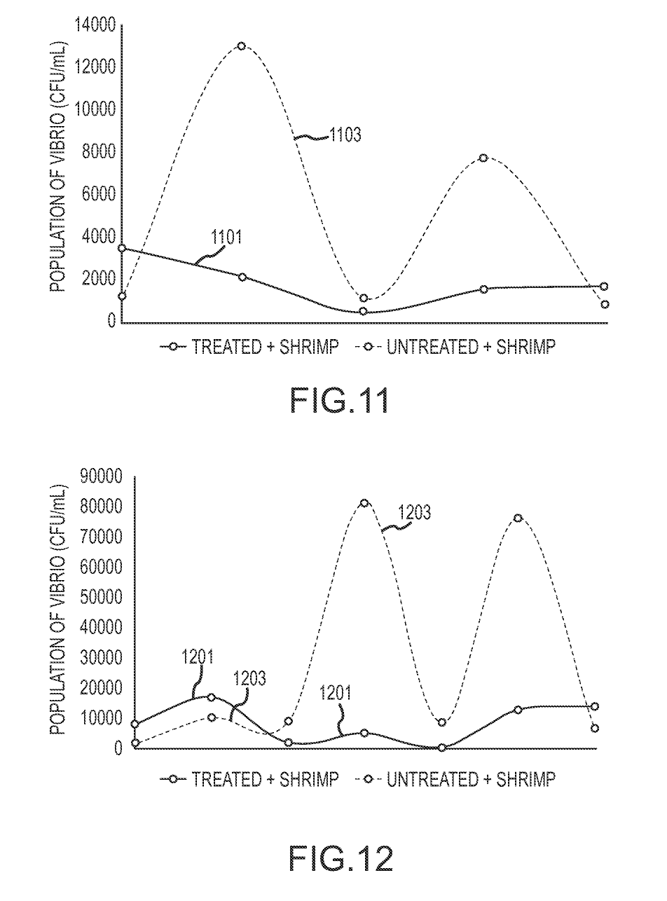

This example further demonstrates that the treated oxygen-containing gas generated as described in Example 1 is successful at reducing and controlling Vibrio parahaemolyticus growth over a 47 day period, while keeping substantially most of the shrimp alive (93% survival) (see the FIGS. 11 and 12). Shrimp were present during the duration of the study.

A water tank containing shrimp were treated with the treated oxygen-containing gas generated as described in Example 1 at rate of 120 L/mins, while a second tank also containing shrimp was not treated with the treated oxygen-containing gas. As shown in FIG. 11, the population of V. parahaemolyticus in water with shrimp remained low and controlled in the tank treated continuously with the treated oxygen-containing gas (1101 of FIG. 11), compared to much more sporadic variation in the tank with shrimp and no water treatment (1103 of FIG. 11), thus demonstrating a low, controlled level of V. parahaemolyticus is achieved with the treatment of the oxygen-containing gas.

FIG. 12 shows that the population of V. parahaemolyticus remained low and controlled in the sediment of the tank from FIG. 11 that was treated with the treated oxygen-containing gas (1201 of FIG. 12), as compared to much more sporadic variation in the sediment from the untreated tank with shrimp (1203 of FIG. 12) from FIG. 11. This results further demonstrates the ability to control a low level of V. parahaemolyticus by treating V. parahaemolyticus containing water with the oxygen-containing gas generated as disclosed in Example 1.

### Example 3

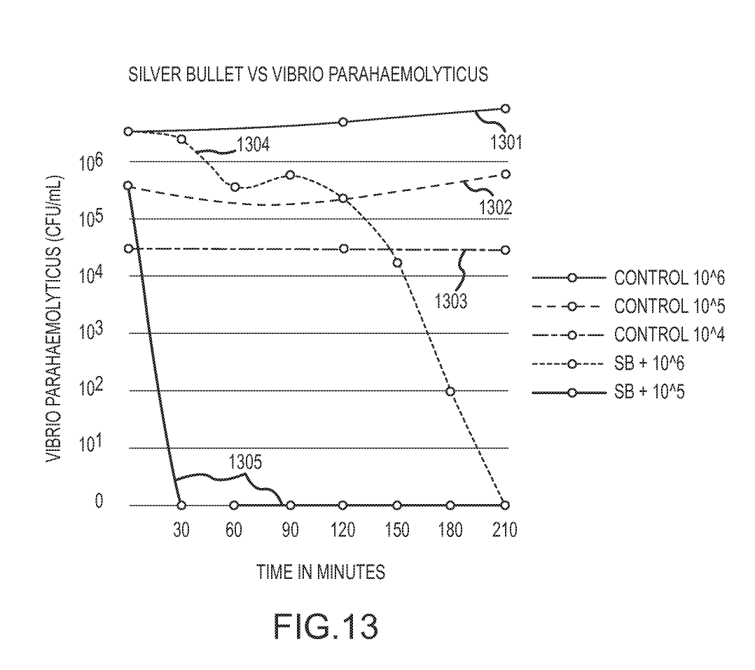

This example demonstrates the verification of kill rates of the treated oxygen-containing gas generated as described in Example 1 on virulent quantities of V. parahaemolyticus. As shown in FIG. 13, treated oxygen-containing gas that was injected into water containing V. parahaemolyticus, reduced the V. parahaemolyticus populations from 10⁵ to zero in less than 30 minutes of continuous dosing at a rate of 10 L/min and from 10⁶ to zero in 3.5 hours (1305 of FIG. 13) of continuous dosing at a rate of 10 L/min.

### Example 4

This example describes reducing and controlling the levels Vibrio parahaemolyticus (VP) and other species of Vibrio (such as Vibrio cholera) in water treated with the treated oxygen-containing gas generated as described in Example 1.

Three treatment tanks (i.e. Treatment A, B or C) of 250 mL of seawater were used. Treatment A and B were dosed (or contacted) with different levels of the most pathogenic strain of V. parahaemolyticus (VP). Bacteria growth was verified by a Thiosulfate-citrate-bile salts-sucrose agar (TCBS) method which constitutes an agar that specifically selects for Vibrio genus bacteria. Some species of the Vibrio genus will grow as yellow colonies (such as V. cholera, V. alginolyticus, V. fluvialis, V. furnissll, and V. metschnikovll (reduced growth)) and other species will grow as green colonies. VP is visible as a component of the green colony growth. Other Vibrio species that can grow as green colonies include V. mimicus, V. damsel, V. hollisae (poor growth) and V. vulnificus (mostly green 85% of the time but can be yellow about 15% of the time). In Table IV below, “G” represents green colonies, while “Y” represents yellow colonies.

Treatment A: 10⁶ of VP was added. The treated oxygen-containing gas (also referred to herein as “SBG”) was added at 10 L/min for 2.5 hours to bring the VP levels down below 10⁶ prior to adding 5 shrimp. Following addition of the shrimp, the tank was dosed with the treated oxygen-containing gas at 10 L/min for 15 min and then left off for 75 minutes in order to maintain the VP below 10⁶, but keep the levels above zero. The results show that all shrimp similarly died after being in a tank that had VP at levels as high as 10⁶.
Treatment B: 10⁴ VP was added to this tank and was dosed (i.e. contacted) with the treated oxygen-containing gas (10 L/min for 15 min on and 75 min off) in order to control VP growth and maximize shrimp survival. Mortalities were observed following the dosing of the treated oxygen-containing gas of the present invention that brought the VP levels to zero (see Tables VI and V).
Treatment C: This was the control tank, which was dosed with 10⁴ of VP and received no treated oxygen-containing gas. The results from this control demonstrated that maintaining a presence of Vibrio at a low level was important to promote the natural competition of beneficial bacteria over the pathogenic VP strain. In Treatment C, the yellow colonies naturally out competed the green over time. In Treatments A and B, the green colonies dominated following either too great of a density of VP (10⁶) or following excessive dosing of the treated oxygen-containing gas of the present invention.

TABLE IV

| | Treatment A (10⁶) | | | Treatment B (10⁴) | | | |
|---|---|---|---|---|---|---|---|
| | | | After 75 min | | | After 75 min | |
| Sample | | After 15 min | Off | | After 15 min | Off | Control |
| Time | No TG | TG | TG | No TG | TG | TG | (10⁶) |
| Cycle 1 | 1.05 × 10³ | 2.85 × 10³ | 1.48 × 10⁴ | 2.6 × 10⁴ | 0 | 3.65 × 10² | 3.75 × 10⁴ |
| 4:00 PM | G = 100% | G = 100% | G = 100% | G = 100% | | | G = 100% |
| Cycle 3 | 4.35 × 10⁴ | 3.2 × 10⁴ | 5.65 × 10⁴ | 0 | 0 | 5 | 6.55 × 10⁴ |
| 7:00 PM | G = 100% | G = 100% | G = 100% | | | G = 100% | G = 100% |
| Cycle 12 | 4.5 × 10³ | 3.5 × 10⁴ | 1.5 × 10⁴ | 0 | — | — | 3.05 × 10⁴ |
| 6:30 AM | G = 100% | G = 100% | G = 100% | | | | G = 95% |
| | | | | | | | Y = 5% |
| Cycle 16 | 2.05 × 10⁴ | 1.55 × 10³ | — | 3.25 × 10² | 3.0 × 10¹ | — | 3.5 × 10³ |
| 2:30 PM | G = 100% | G = 100% | | G = 80% | G = 100% | | G = 61% |
| | | | | Y = 20% | | | Y = 39% |
| Cycle 29 | 1.69 × 10⁴ | 7.4 × 10³ | 8.55 × 10⁴ | 3.86 × 10³ | 1. × 10² | — | 3.75 × 10³ |
| 10:00 | G = 100% | G = 100% | G = 100% | G = 85% | G = 55% | | G = 40% |
| AM | | | | Y = 15% | Y = 45% | | Y = 60% |
| Cycle 33 | 4.2 × 10² | 2.89 × 10³ | 3.05 × 10³ | 5.15 × 10² | 7.95 × 10² | 7.75 × 10² | 2.95 × 10³ |
| 4:00 PM | G = 100% | G = 100% | G = 100% | G = 100% | G = 80% | G = 100% | G = 46% |
| | | | | | Y = 20% | | Y = 54% |
| Cycle 79 | 0 | 0 | — | 0 | 0 | — | 4.0 × 10² |
| 1:00 PM | | | | | | | G = 12% |
| | | | | | | | Y = 88% |

Depicts VP growth in three treatment tanks, A, B and C. Treatment A and B were dosed (contacted) with 10 L/min treated gas (TG) for cycles of 15 minutes on and 75 minutes off. The control tank was originally dosed with 10⁴ of VP and received no treated gas (TG). “G” represents green colonies; “Y” represents yellow colonies.

TABLE V
Mortalities (Numbers of Shrimps)

| Time | Treatment A (10⁶) | Treatment B (10⁴) | Control (10⁴) |
|---|---|---|---|
| After 7 Hours | 3 | 0 | 0 |
| Post-Infection | | | |
| After 9 Hours | 1 | 0 | 0 |
| Post-Infection | | | |
| After 28 Hours | — | 1 | 0 |
| Post-Infection | | | |
| After 30 Hours | 1 | 0 | 0 |
| Post-Infection | | | |
| After 45 Hours | — | 1 | 0 |
| Post-Infection | | | |

100% mortality was observed in Treatment A (exposure to 10⁶ VP infected water). 40% mortality was observed in Treatment B, following the treated gas achieving levels of zero VP. 100% survival occurred in the control tank of 10⁴ VP. “--” means data was not obtained

### Example 5

This example demonstrates the reduction of Vibrio parahaemolyticus (VP) to below 10⁶ CFU/ml and above zero to promote beneficial bacteria and competitive exclusion, thus keeping the shrimp alive.

Bacteria growth was verified by the Thiosulfate-citrate-bile salts-sucrose agar (TCBS) method as discussed in Example 4.

Treatment A: 10 L/min of the treated oxygen containing gas (SB) generated as described in Example 1 was added at cycles of 5 minutes on and 85 minutes off to a 250 mL tank of salt water with 10⁴ VP at 10 L/min. This dosing successfully maintained the total VP level below the threshold (˜10⁶ CFU/ml) and above zero CFU and all of the shrimp survived. See Table VI.
Treatment B: This constituted the same set up as Treatment A, however additional nutrients were added to promote VP growth. This dosing (i.e. contacting) successfully maintained the total VP level below the treshold (˜10⁶ CFU/ml) and above zero CFU/ml and all of the shrimp survived. See Table VI.
Treatment C: The control tank was dosed with 10⁴ CFU of VP and additional nutrients to try to promote VP growth so it would reach 10⁶ and kill the control shrimp. The VP count remained below 10⁶ CFU/ml however and all of the shrimp survived. The results from this control further verified the importance of the natural interaction and competition that occurs between different Vibrio species as long as the overall VP density is maintained below a threshold.

Each cycle of Table VI included 5 minutes of treatment with treated gas as described above and 85 minutes of treatment with air (not-treated gas).

Also shown in Table VI is the reduction of other species of Vibrio, such as Vibrio cholera, as shown by the reduction in the “Y” or yellow colonies which include Vibrio cholera.

TABLE VI

| | | | | Treatment B | | | |
|---|---|---|---|---|---|---|---|
| | Treatment A (10⁴) | | | (Additional Nutrients) (10⁴) | | | |
| | Before | 5 min | 85 min | Before | 5 min | 85 min | Control (10⁴) |
| | TG | After TG | without TG | TG | After TG | without TG | Without TG |
| Cycle 1 | 9.6 × 10⁴ | 9.4 × 10⁴ | 1.1 × 10⁵ | 9.9 × 10⁴ | 7.9 × 10⁴ | 1.0 × 10⁵ | 9.5 × 10⁴ |
| Start | G = 100% | G = 100% | G = 100% | G = 100% | G = 100% | G = 100% | G = 100% |
| Cycle 2 | 4.4 × 10⁴ | 1.4 × 10⁴ | 1.7 × 10⁴ | 7.6 × 10⁴ | 6.8 × 10⁴ | 1.1 × 10⁴ | 1.1 × 10⁵ |
| 3 hpi | G = 100% | G = 100% | G = 100% | G = 100% | G = 100% | G = 100% | G = 100% |
| Cycle 14 | 4.6 × 10² | 7.0 × 10¹ | 4.0 × 10² | 8.5 × 10² | 9.5 × 10³ | 3.9 × 10³ | 7.0 × 10⁴ |
| 21 hpi | G = 88% | G = 93% | G = 90% | G = 94% | G = 96% | G = 96% | G = 100% |
| | Y = 12% | Y = 7% | Y = 10% | Y = 6% | Y = 4% | Y = 4% | |
| Cycle 17 | 2.5 × 10² | 1.5 × 10² | 1.4 × 10² | 1.5 × 10³ | 1.2 × 10² | 1.9 × 10³ | 3.7 × 10⁴ |
| 25.5 hpi | G = 72% | G = 58% | G = 30% | G = 99% | G = 100% | G = 45% | G = 99% |
| | Y = 28% | Y = 42% | Y = 70% | Y = 1% | | Y = 55% | Y = 1% |
| Cycle 29 | 7.2 × 10² | 1.6 × 10³ | 4.8 × 10² | 1.9 × 10⁴ | 2.5 × 10³ | 4.1 × 10⁴ | 5.7 × 10² |
| 23.5 hpi | G = 55% | G = 85% | G = 60% | G = 87% | G = 87% | G = 45% | G = 40% |
| | Y = 45% | Y = 15% | Y = 40% | Y = 13% | Y = 13% | Y = 55% | Y = 60% |
| Cycle 32 | 2.4 × 10³ | 3.1 × 10² | 5.7 × 10² | 2.9 × 10³ | 1.9 × 10³ | 1.0 × 10⁴ | 1.2 × 10³ |
| 48 hpi | G = 40% | G = 40% | G = 55% | G = 88% | G = 80% | G = 76% | G = 66% |
| | Y = 60% | Y = 60% | Y = 45% | Y = 12% | Y = 20% | Y = 24% | Y = 34% |
| Cycle 44 | 8.4 × 10² | 3.2 × 10² | 2.5 × 10³ | 9.3 × 10³ | 5.4 × 10³ | 9.0 × 10² | 1.6 × 10³ |
| 66 hpi | G = 25% | G = 30% | G = 91% | G = 89% | G = 79% | G = 46% | G = 60% |
| | Y = 75% | Y = 70% | Y = 9% | Y = 11% | Y = 21% | Y = 54% | Y = 40% |
| Cycle 47 | 1.1 × 10³ | 7.7 × 10³ | 3.9 × 10³ | 5.9 × 10³ | 1.1 × 10⁴ | 2.4 × 10³ | 2.1 × 10³ |
| 70.5 hpi | G = 49% | G = 14% | G = 24% | G = 94% | G = 89% | G = 84% | G = 40% |
| | Y = 51% | Y = 86% | Y = 76% | Y = 6% | Y = 11% | Y = 16% | Y = 60% |
| Cycle 59 | 1.4 × 10³ | 2.2 × 10² | 3.0 × 10³ | 1.2 × 10² | 4.0 × 10³ | 2.4 × 10² | 4.7 × 10³ |
| 88.5 hpi | G = 45% | G = 10% | G = 2% | G = 85% | G = 26% | G = 70% | G = 42% |
| | Y = 55% | Y = 90% | Y = 98% | Y = 15% | Y = 74% | Y = 30% | Y = 58% |

Unit forming colonies during exmperimental infection with Vibro Parahaemolyticus (Vp) followed by treated gass (TG) injection.

### Example 6

This example describes methods for monitoring and controlling the levels Vibrio parahaemolyticus in water treated with the treated oxygen-containing gas generated as described in Example 1.

Eight 400 L tanks are filled with ˜250 L of seawater. Salinity in the tanks is adjusted to 36 ppt, and each tank contains an aeration system to promote adequate mixing.

Six tanks are inoculated with a Vibrio parahaemolyticus strain (Vp 25/sed) that is positive to EMS/AHPNS primers to a reading of ˜10⁶. The actual amount of bacteria added to each of the tanks is measured and confirmed using the total plate count (TPC) method using TCBS Agar (Thiosulfate Citrate Bile Salts Sucrose Agar). After the six tanks are inoculated with the (Vp 25/sed) isolate; two tanks are not treated treatment with oxygen-containing gas while four tanks are treated with the oxygen-containing gas. From these, two tanks receive probiotics and two tanks do not receive probiotics. A water sample from each tank is taken 2 hours after contact via injection of the treated oxygen-containing gas and every 12 hours afterwards to evaluate the bacterial population for 7 days. Additionally, 10 shrimps are added to each of the six tanks to evaluate survival rate.

### Example 7

This example demonstrates the control of Vibrio cholerae to low levels (i.e., less than 20,000 CFU) in water treated with the treated oxygen-containing gas generated as described in Example 1.

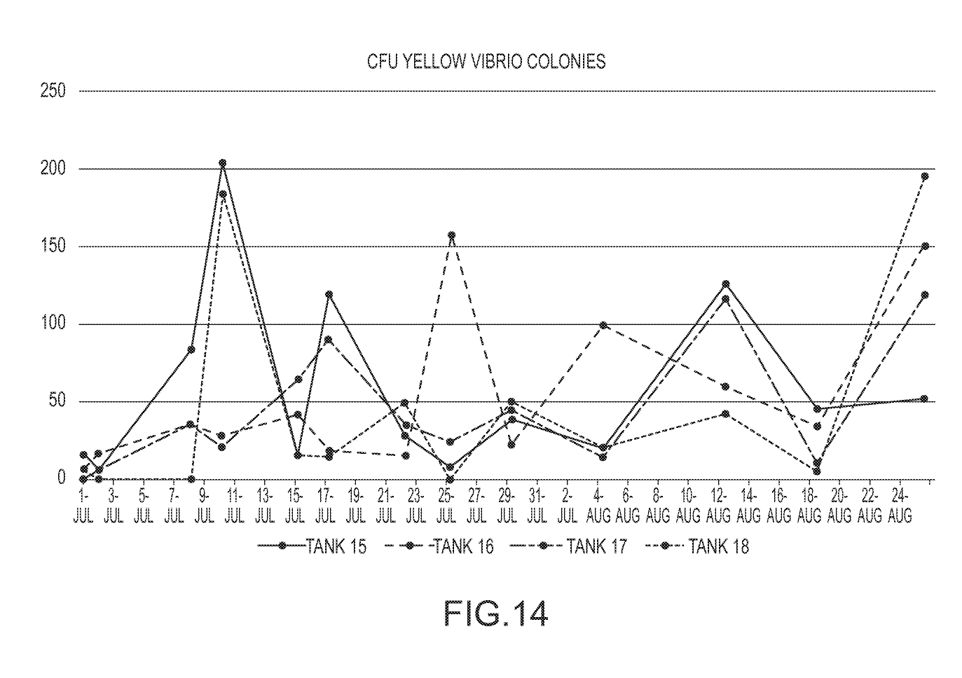

In addition to the smaller scale analysis as described in Examples 4 and 5, a large scale analysis was conducted in a similar manner on four 6 hectare ponds (12 million gallons of water each) where the water was treated (i.e. dosed) with the oxygen-containing gas. The results verified that the oxygen-containing gas was able to control the numbers of yellow Vibrio colonies, including Vibrio cholerae, to low levels and limited the growth to within the intended range (below 20,000 CFU). The controlled growth of colony forming unit values for yellow Vibrio colonies are provided in FIG. 14. Dosing of the oxygen-containing gas ranged over a 120-day period and varied from 0-4000 L/min based on environmental conditions such water temperature, air temperature, presence or absence of sunlight, presence or absence of rain, as well as on the oxidation reduction potential values present in the water and bacterial growth rate values.

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

What is claimed:

1. A method to one or more of:
(i) control the level of bacteria of the species of Vibrio and combinations thereof in bacteria-containing water;
(ii) reduce the level of bacteria of the species of Vibrio and combinations thereof in bacteria-containing water; and
(iii) inhibit growth of bacteria of the species of Vibrio and combination thereof in water, comprising:
providing a treated oxygen-containing gas generated by passing an oxygen-containing gas stream through ultra-violet radiation in a magnetic field; and
contacting the bacteria-containing water with the treated oxygen-containing gas to form a treated water, wherein at least one of the following is true:
(a) the level of bacteria in the contacted water is controlled as compared to the level of Vibrio bacteria prior to the step of contacting;
(b) the contacted water has a reduced concentration of the bacteria as compared to the level of Vibrio bacteria prior to the step of contacting; and
(c) the contacted water inhibits growth of the bacteria.

2. (canceled)

3. (canceled)

4. The method of claim 1, wherein the level of bacteria is controlled to a level of about 1×10¹ CFU/ml to about 5×10⁷ CFU/ml.

5. The method of claim 1, wherein the level of bacteria is reduced to a level of about 1×10¹ CFU/ml to about 5×10⁷ CFU/ml.

6. The method of claim 1, wherein the growth of bacteria is inhibited to a level of about 1×10¹ CFU/ml to about 5×10⁷ CFU/ml.

7. The method of claim 1, wherein the species of Vibrio is selected from the group consisting of Vibrio parahaemolyticus, Vibrio harveyi, V. campbelli V. owensii, Vibrio cholerae and combinations thereof.

8. The method of claim 7, wherein the species is Vibrio parahaemolyticus.

9. The method of claim 1, wherein the contacted water allows for survival of shrimp growing in the water.

10. The method of claim 1, wherein the bacteria-containing water is in a sealed aerated pond, a marine environment or an aquaculture system.

11. (canceled)

12. A method to reduce the incidence of acute hepatopancreatic necrosis syndrome (AHPNS) caused by the presence of bacteria in shrimp growing in bacteria-containing water, by one or both of reducing and controlling the level of bacteria in the bacteria-containing water comprising:
providing a treated oxygen-containing gas generated by passing an oxygen-containing gas stream through ultra-violet radiation in a magnetic field; and
contacting the bacteria-containing water with the treated oxygen-containing gas to form a treated water, wherein the contacted water has a level of bacteria of about 1×10¹ CFU/ml to about 5×10⁷ CFU/ml as compared to prior to the step of contacting.

13. (canceled)

14. A method to treat shrimp growing in bacteria-containing water having acute hepatopancreatic necrosis syndrome caused by the presence of bacteria, by one or both of reducing and controlling the level of bacteria in the bacteria-containing water comprising:
providing a treated oxygen-containing gas generated by passing an oxygen-containing gas stream through ultra-violet radiation in a magnetic field; and
contacting the bacteria-containing water with the treated oxygen-containing gas, to form a treated water, wherein the contacted water has a level of bacteria of about 1×10¹ CFU/ml to about 5×10⁷ CFU/ml as compared to prior to the step of contacting.

15. (canceled)

16. The method of claim 12, wherein the bacteria is of the species Vibrio.

17. The method of claim 16, wherein the Vibrio species is selected from the group consisting of Vibrio parahaemolyticus, Vibrio harveyi, V. campbelli, V. owensii, Vibrio cholerae and combinations thereof.

18. The method of claim 1, wherein the water is contacted until the level of bacteria in the water is about 1×10¹ CFU/ml to about 5×10⁷ CFU/ml.

19. The method of claim 18, wherein the water is contacted continuously during the step of contacting.

20. The method of claim 18, wherein the water is contacted at two or more different intervals during the step of contacting.

21. The method of claim 1, wherein the step of contacting can be selected from the group consisting of forming a dispersion of the treated oxygen gas in the water, bubbling the treated oxygen gas into the water, and introducing the treated oxygen gas through a venturi effect to the water.

22. The method of claim 1, wherein the with ultra-violet radiation has a first wavelength within a range from about 178 nm to about 187 nm and a second wavelength with a range from about 252 nm to about 256 nm.

23. The method of any one of claim 1, where the magnetic field is established by one of:
(i) a set of magnets with magnetic fields aligned to one of attract an adjacent magnet or repel an adjacent magnet;
(ii) a plurality of permanent magnets;
(iii) a plurality of electromagnets; or
(v) two parallel sets of magnets with one of opposing or attractive magnetic poles.

24. The method of claim 15, wherein the water is contacted until the level of bacteria in the water is about 1×10¹ CFU/ml to about 5×10⁷ CFU/ml.

25. The method of claim 24, wherein the water is contacted continuously during the step of contacting.

26. The method of claim 24, wherein the water is contacted at two or more different intervals during the step of contacting.

27. The method of claim 15, wherein the step of contacting can be selected from the group consisting of forming a dispersion of the treated oxygen gas in the water, bubbling the treated oxygen gas into the water, and introducing the treated oxygen gas through a venturi effect to the water.

28. The method of claim 15, wherein the with ultra-violet radiation has a first wavelength within a range from about 178 nm to about 187 nm and a second wavelength with a range from about 252 nm to about 256 nm.

29. The method of any one of claim 15, where the magnetic field is established by one of:
(i) a set of magnets with magnetic fields aligned to one of attract an adjacent magnet or repel an adjacent magnet;
(ii) a plurality of permanent magnets;
(iii) a plurality of electromagnets; or
(v) two parallel sets of magnets with one of opposing or attractive magnetic poles.
